(19) United States
(12) Patent Application Publication
(10) Pub. No.: US 2006/0270473 A1
(43) Pub. Date: Nov. 30, 2006

(54) Combine shoe with airflow-control

(76) Inventor: James Straeter, Rochester, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 11/347,085

(22) Filed: Feb. 3, 2006

Related U.S. Application Data
(63) Continuation-in-part of application No. PCT/US04/26771, filed on Aug. 19, 2004.
(60) Provisional application No. 60/649,730, filed on Feb. 3, 2005.

(51) Int. Cl. A01F 12/48

(52) U.S. Cl. 460/99

(57) ABSTRACT

A sealing system for the shoe in a combine harvester is disclosed wherein the separate flow areas in the shoe are sealed from one another. The sealing system discourages air from traveling through the components of the shoe other than the sieve system, thereby providing flow of air to the sieves. The positive differential and the containment of air in the shoe are accomplished by providing one or more seals between the moving shoe components and the stationary frame components. In those combines including self-leveling shoe assemblies, the distance between the shoe assembly rolls to maintain level operation. Various embodiment of this invention provide for sealing this change in the dimensions as the shoe moves.

### CROSS REFERENCE TO RELATED APPLICATIONS

The present invention claims the benefit of priority to U.S. Provisional Patent Application Ser. No. 60/649,730, filed Feb. 3, 2005, which is incorporated herein by reference.

### FIELD OF THE INVENTION

The invention relates to methods and apparatus for controlling the flow of air in a combine, especially a combine with a self-leveling shoe assembly.

### BACKGROUND OF THE INVENTION

A significant advance in the field of harvesting farm products is the addition of a reciprocating shoe assembly to a combine. A quantity of air is blown over a pair of reciprocating sieves. The combination of reciprocating motion and airflow separates the harvested product from unwanted chaff. By careful control of the flow of air, the oscillating motion of the sieves, and the location of the shoes, the separated product is fed into one auger, and the unwanted chaff is discharged.

However, as the combine traverses along the side of a hill, the efficiency of separation by the shoes is affected by the inclination of the combine. With the advent of the self-leveling shoe assembly (such as that described in U.S. Pat. No. 4,344,443, incorporated herein by reference), the efficiency of separation is somewhat restored. The self-leveling feature permits the pair of reciprocating sieves to stay in a more constant orientation relative to gravity, and the harvested product is more consistently separated.

However, one problem with some self-leveling shoe assemblies is inadequate control of air flowing within the combine. In some applications, the lower partition between the bottom of the shoe assembly and the static floor of the combine is fixed such that underside gaps are created when the shoe assembly pivots to maintain level operation. Air is permitted to flow through this unwanted gap, which affects the pattern of air flowing over the sieves for separation of the product. Separation is thus made less efficient. Further, in some self-leveling shoes there are largely unsealed gaps on the lateral sides of the shoe assembly (gaps between the lateral sides of the pivoting structure and the non-pivoting, static structure that faces the pivoting structure). In these applications, air can flow unimpeded around the sides of the self-leveling shoe, even when the combine is level and the shoe is not pivoted.

What is needed are apparatus and methods for improved airflow control of self-leveling shoes. The present invention does this in novel and unobvious ways.

### SUMMARY OF INVENTION

It is one aspect of some embodiments of this invention to overcome the disadvantages of other designs by providing a separation of flow areas in the self-leveling shoe.

It is another aspect of some embodiments of this invention to provide for any type of seals which would accomplish this separation.

It is another aspect of some embodiments of this invention to provide for adjustment of the separation effectiveness, both during operation of the combine and during non-operation.

It is another aspect of some embodiments of this invention to allow for the separation of the areas as described without impeding the ‘double action’ of the shoe whereby the upper sieve moves in the opposite direction of the lower sieve.

It is another aspect of some embodiments of this invention to provide for operation without input by the operator.

It is another aspect of some embodiments of this invention to seal off areas and thereby prevent both air and grain movement between certain components.

It is another aspect of some embodiments of this invention to reduce or eliminate recirculation of air provided from a fan.

It is another aspect of some embodiments of this invention to reduce or eliminate recirculation of air from the fan outlet to the fan intake.

It is another aspect of some embodiments of this invention to reduce or eliminate recirculation under the clean grain pan.

It is another aspect of some embodiments of this invention to use an apparatus such as an air lock or one-way valve to control the direction of the flow of air over the clean grain auger.

It is a further intention of some methods of some embodiments to provide a supplemental air control to other methods which are intended to contain air inside the self-leveling shoe. By providing these methods to reduce or eliminate re-circulation of air, cleaning efficiency is enhanced and overall productivity of the combine can be improved.

These and other aspects of various embodiments of the invention will be apparent from the drawings, description and claims to follow.

### DESCRIPTION OF THE DRAWINGS

FIG. 1 is a partially cutaway, side elevational view of a known combine.

FIG. 2 is a close-up of a portion of the combine of FIG. 1.

FIG. 3 is a close-up of the self-leveling shoe of the combine of FIG. 1.

FIG. 4 is a view of the apparatus of FIG. 3 as taken along line 4-4.

FIG. 5A is a cutaway side elevational view of an apparatus according to one embodiment of the present invention.

FIG. 5B is a view of the apparatus of FIG. 5A as taken along line 5B-5B.

FIG. 5C is a view of a seal member of FIG. 5B as taken along line 5C-5C.

FIG. 6A is a cutaway, side elevational view of an apparatus according to another embodiment of the present invention.

FIG. 6B is a schematic representation of the apparatus of FIG. 6A as taken along line 6B-6B.

FIG. 7A is a schematic representation of an end view of an apparatus according to another embodiment of the present invention.

FIG. 7B is a cutaway of the apparatus of FIG. 7A as taken along line 7B-7B.

FIG. 8 is a cutaway, side elevational view of an apparatus according to another embodiment of the present invention.

FIG. 9 is a cutaway, centerline, side elevational view of an apparatus according to another embodiment of the present invention.

FIG. 10 is a top, rearward-facing perspective view of an apparatus according to another embodiment of the present invention.

FIG. 11 is a close up view of a portion of the apparatus of FIG. 10.

FIG. 12 is a perspective view of the right forward portion of the apparatus of FIG. 10.

FIG. 13 is a perspective view of a portion of the right side of the apparatus of FIG. 10 as viewed from behind.

FIG. 14 is a perspective view of a portion of the right side of the apparatus of FIG. 10 as viewed from above.

FIG. 15 is a cutaway, centerline, side elevational view of the apparatus of FIG. 10.

FIG. 16 is a top plan view of an exploded, disassembled sealing kit according to another embodiment of the present invention.

FIG. 17 is a cutaway, side elevational view of an apparatus according to another embodiment of the present invention.

FIG. 18 is a cutaway, side elevational view of an apparatus according to another embodiment of the present invention.

FIG. 19 is a cutaway, side elevational view of an apparatus according to another embodiment of the present invention.

FIG. 20 is a schematic representation of an apparatus according to another embodiment of the present invention as viewed in a direction and at a position similar to that of FIG. 6A.

FIG. 21 is a photographic side view of a portion of a combine according to another embodiment of the present invention.

FIG. 22 is a photographic top view looking down on the apparatus of FIG. 21.

FIG. 23 is a partially cutaway, side elevational view of a combine according to another embodiment of the present invention.

FIG. 24 is a side elevational schematic representation of airflow exiting a fan of a prior art combine.

FIG. 25 is a photographic end view of a rear seal and bracket according to one embodiment of the present invention.

FIG. 26 is photograph of a left bracket mounted with a seal surface according to one embodiment of the present invention.

FIG. 27 is a photograph of the left seal area according to one embodiment of the present invention, as installed in a test rig.

FIG. 28 is a photograph of a left seal surface according to one embodiment of the present invention.

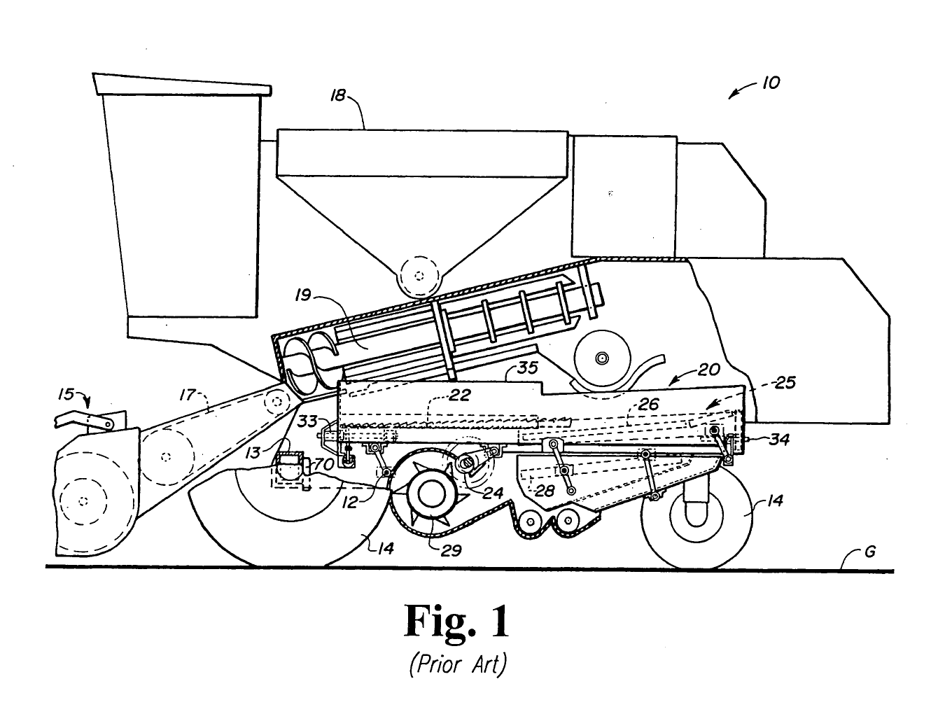

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The present invention relates generally to combine harvesters and more particularly, to improvements in the cleaning apparatus which permit leveling of the cleaning components in non-level field operation. It has been shown that by keeping the cleaning components level there are benefits of even distribution of grain in the cleaning area as well as more consistent air flow owing to consistent depth of grain and MOG (material other than grain). Such a system is described in patents U.S. Pat. Nos. 4,535,788 and 3,731,470 and 4,344,443, all incorporated herein by reference. These separate patents described different methods of keeping the sieves level. This application pertains to any self-leveling systems where a change in orientation occurs between the cleaning components and some of the frame components of the combine.

This application includes sealing systems and pertains to the idea of providing seals proximate to the self-leveling systems with some specific non-limiting examples of type of seals. In some embodiments of the present invention, the methods and apparatus disclosed herein pertain to redirecting airflow which could otherwise be described as leakage or misdistributed flow to instead flow through the lower shoe to better assist in cleaning. The application also covers methods using seals or not using seals which could provide for differentiation of air pressure in redirection of airflow to components in a shoe which change orientation to provide for levelness during operation.

A fan 29 provides air pressure to the front of the shoe assembly 20 including upper and lower reciprocating sieves 26 and 28, respectively. This air can pass through the sieves, thereby carrying lighter material (usually MOG) with it for delivery out of the combine while leaving heavier material (usually grain) falling through the sieves for delivery to the tank 18 via the clean grain auger 106.

In some known combines with self-leveling shoes, air is allowed to pass under the lower shoe components through the auger area and up the tailings transport area 3 to the rear of the lower shoe or sieve 6, thereby avoiding passing through the shoe or sieve itself. Heavier crops are especially susceptible to this misdirection of airflow since they provide more air blockage while on sieves. The air which is delivered to the rear of the lower sieve effectively neutralizes, or greatly reduces, the difference in pressure under the lower sieve compared to the pressure above the lower sieve. This reduction/neutralization stalls or reduces airflow through the sieve and impedes the cleaning effectiveness of the air system.

In a combine harvester equipped with a shoe that maintains level orientation regardless of the tilt of the combine frame, a sealing system may be provided to separate certain areas of the cleaning shoe. In some embodiments of the present invention there is a provision of pressure differentiation that can be accomplished in other manners such as by a second fan, compressor, or other active pressurizing device in the cleaning shoe area separate from fan 29. It could also be provided by such a device located outside of the shoe area being connected to the shoe by an air delivery system. Various embodiments of this invention pertain to all types of sealing apparatus, methods, and blowing devices that provide separate pressure areas in a self-leveling shoe. In those embodiments in which a second fan or blower is installed, it may also be desirable to control the speed of both fans to provide the correct flow of air through the lower shoe.

In some cases, significant airflow and pressure differentiation may not be desirable, such as light grass seed crops. It may also be beneficial to be able to adjust the differentiation either “on the go” or while not in operation. It is the intent of this application to include the capability to adjust how much sealing is done and thereby adjust how much airflow and pressure differentiation is provided for crop cleaning.

Referring to FOGS 1-4, a side elevational view of a known combine is shown. Although specific reference to a known combine will be made, the present invention is not limited in its application to any specific combine, and is generally applicable to any combine having a self-leveling shoe. Any left and right references are used as a matter of convenience and are determined by standing at the front of the machine, facing the rearward end. The combine 10 is provided with a main frame 12 having at least one transversely disposed beam 13 mobilely supported over the ground G by wheels 14. A crop harvesting header 15 is forwardly supported from the frame 12 to gather crop material and convey it rearwardly via a feeding mechanism 17 to a threshed and separating mechanism 19. The threshing and separating mechanism 19 is operable to thresh the crop material fed thereto and separate the threshed grain from the trash material to precipitate the threshed grain downwardly through the threshing and separating mechanism 19 and to discharge the trash material along a separate path to be deposited on the ground G rearward of the combine 10.

A shoe or sieve assembly 20 is positioned beneath the threshing and separating mechanism 19 to receive the threshed grain precipitated therefrom on a grain pan 22. Generally, the shoe assembly 20 is operatively connected to an eccentric drive 24 to affect a generally fore-and-aft reciprocating movement of the shoe assembly 20 to convey the thresh grain in a rearward direction. A sieve means 25 is positioned rearwardly of the grain pan 22 to receive threshold grain conveyed rearwardly therefrom and clean the threshed grain from chaff and other debris conveyed therewith. Typically, the sieve means 25 includes an upper chaffer shoe 26 and a lower cleaning shoe 28 mounted for opposing fore-and-aft reciprocating movement and in flow communication with air being blown from a fan 29 upwardly through the shoe 26,28 to remove chaff and debris from the threshed grain. Cleaned grain passing through the sieve means 25 is conveyed into a storage tank 18 supported on the main frame 12.

The grain pan 22 and chaffer shoe 26 are mounted in a subframe 31 which in turn is pivotally supported by fore-and-aft extending and longitudinally spaced pivots 33, 34 within a shaker shoe 35. A tailings return section 27 is positioned at the rear of the chaffer shoe 26 and is pivotally movable therewith. The tailings return section 27 is cooperable with conventional apparatus for the return of unthreshed heads to the threshing and separating means 19. The shaker shoe 35 is pivotally supported from the frame 12 by connecting links 36, 37 incorporating rubber bushings in a conventional manner to permit a fore-and-aft reciprocating movement induced by a drive arm 38 interconnecting the shaker shoe 35 and the eccentric drive 24. The lower cleaning shoe 28 is supported from the frame 12 by connecting links 37, 39 in a similar manner to permit a fore-and-aft reciprocating movement. By utilizing the center connecting link 37 with a frame mounting point intermediate the connection between the shaker shoe 35 and the lower cleaner shoe 28, the shaker shoe 35 and lower shoe 28 are drivingly reciprocating in opposing fore-and-aft directions in a manner conventionally known by one skilled in the art.

Further details of the operation of combine 10 can be found in U.S. Pat. No. 4,535,788, incorporated herein by reference. Shoe assembly 20 is self-leveling in response to the attitude of combine 10. As combine 10 moves on an inclined field and rolls relative to the combine's longitudinal axis, the change in attitude is detected by a sensor. The sensor signal is provided to an electronic controller which is operatively connected to shoe assembly 20 and capable of rolling shoe assembly 20 to keep upper shoe 26 and lower shoe 28 generally level relative to gravity. Although a particular apparatus for separating threshed grain in a self-leveling shoe assembly has been shown and described, the present invention is not so limited. The present invention contemplates usage with any type of self-leveling shoe assembly.

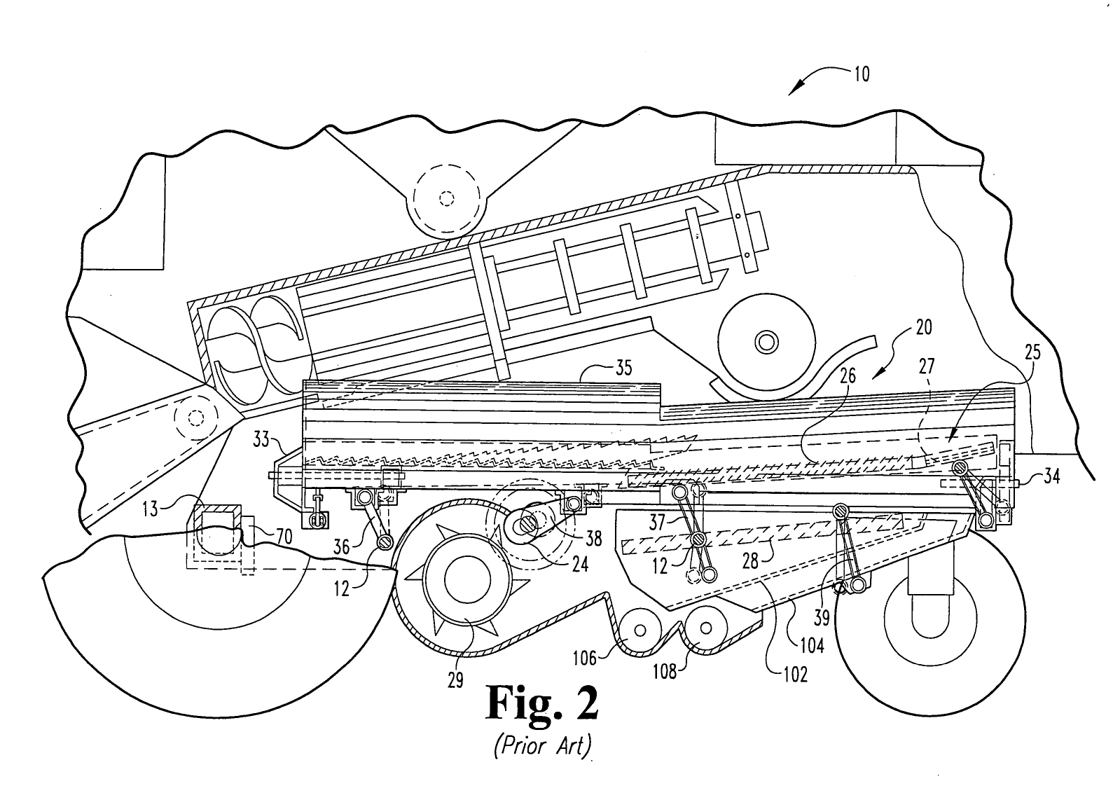

Referring again to FIG.2, combine 10 includes a clean grain slide 102 which is located below lower cleaning sieve 28. Grain being sifted through lower sieve 28 falls onto lower clean grain slide 102 and under gravity slides into clean grain auger 106, which transports the clean grain to an elevator (not shown) and on to storage. Tailings coming off upper sieve 26 fall onto the aft portion tailings pan 104, which is located generally underneath clean grain pan 102. Tailings and chaff falling into the area 107 between the end of the clean grain slide 102 and end of the tailings pan 104 fall down along the tailings pan and into tailing auger 108, which transports the tailings for a subsequent reseparation by shoe assembly 20.

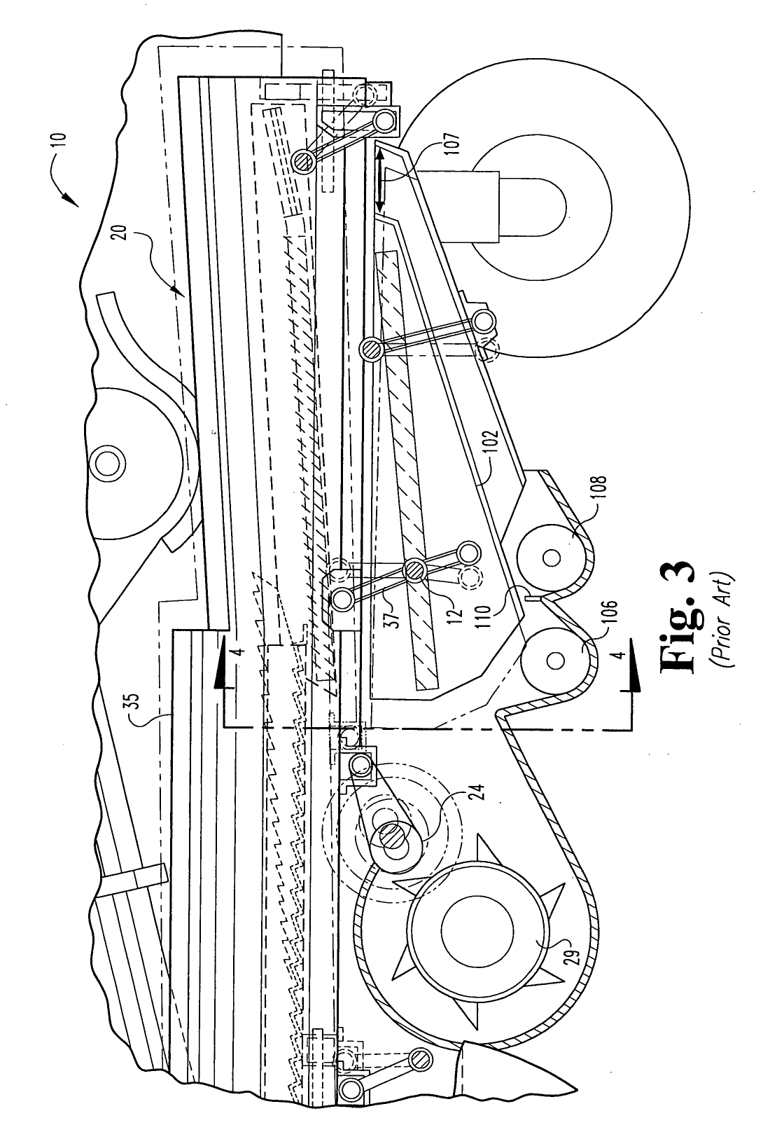

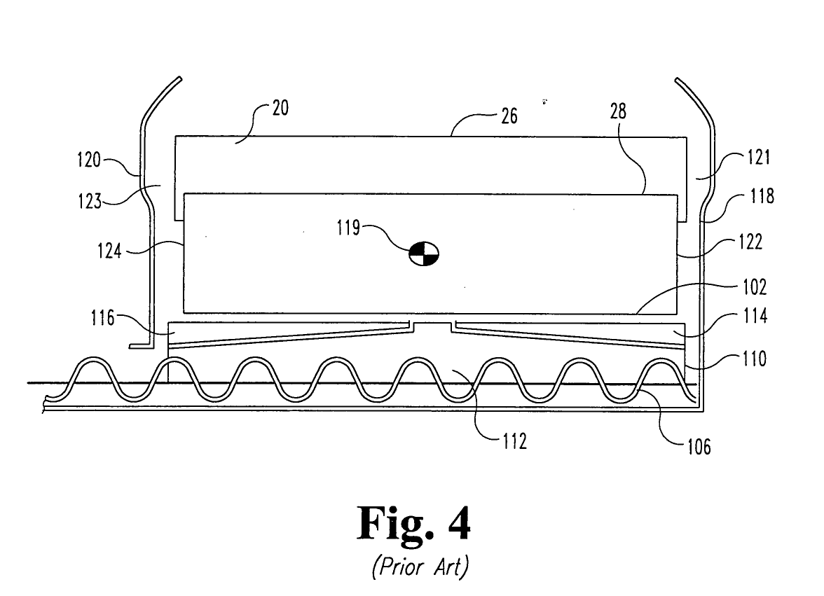

Referring to FIGS. 3 and 4, combine 10 includes a static seal 110 which is attached to the bottom of the combine between augers 106 and 108. This stationary seal is shown again in FIG. 4 as viewed along the longitudinal axis of combine 10. Seal assembly 110 includes a metal holding structure 112 which is attached to static structure of combine 10. Right and left flexible seals 114 and 116, respectively, are attached to structural member 112. The upward ends of flexible seals 114 and 116 are located below the bottom of shoe assembly 20, either below clean grain slide 102 (as shown in FIG. 3), or alternatively below the pivoting structure of shoe assembly 20 immediately in front of pan 102. Generally, there is a gap between the top edge of seals 114 and 116 and the bottom of shoe assembly 20.

Referring to FIG. 4, shoe assembly 20 with upper shoe 26 and lower shoe 28 is generally centered between right and left static sides 118 and 120, respectively, of combine 10. The typical placement of shoe assembly 20 within combine 10 results in a right side gap or pathway 121 between right side 122 of shoe 20 and right side structural member 118. Likewise, a left side gap or pathway 123 is formed between the left side 124 of shoe assembly 20 and the left side structural portion 120 of combine 10. Air being blown from fan 29 toward shoe 20 is free to flow through either side passage 121 or 123 towards the aft of combine 10. In those situations where shoes 26 and 28 are heavily matted, especially with heavy, wet corn grain, this matting blockage of shoes 26 and 28 results in increased airflow through passageways 121 and 123, as well as underneath shoe assembly 20 and above seal member 110.

Partition members 114 and 116 are both tapered across the width of shoe assembly 20. As best seen in FIG. 4, the interior most end of each seal member is generally narrow and the outmost edge is broader. This change in seal height accommodates pivoting of shoe assembly 20. Since the shoe assembly pivots in the middle, there is relatively little change in the distance between the bottom of shoe assembly 20 and the top seal assembly 110 during pivoting. The greatest change in distance occurs along either side of shoe assembly 20. For example, clockwise pivoting of shoe assembly 20 about rotational center 119 results in increased clearance above seal member 116, and contact between portions of seal member 114 and the bottom of clean grain pan 102. Thus, pivoting movement of shoe assembly 20 results in increased flow of air from fan 29 underneath at least one side of shoe assembly 20. Further, air flowing from fan 29 is free to flow around either side of shoe assembly 20, between the sides of the shoe assembly and the nearby corresponding static structure of combine 10.

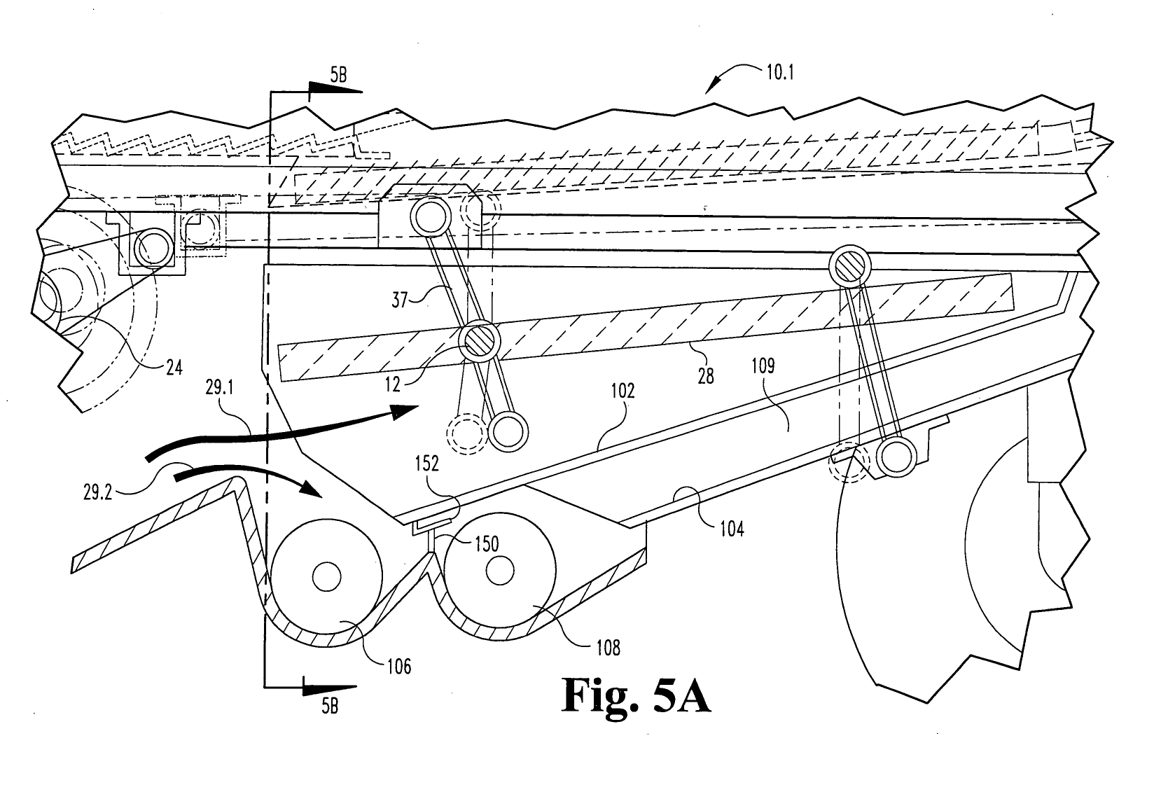

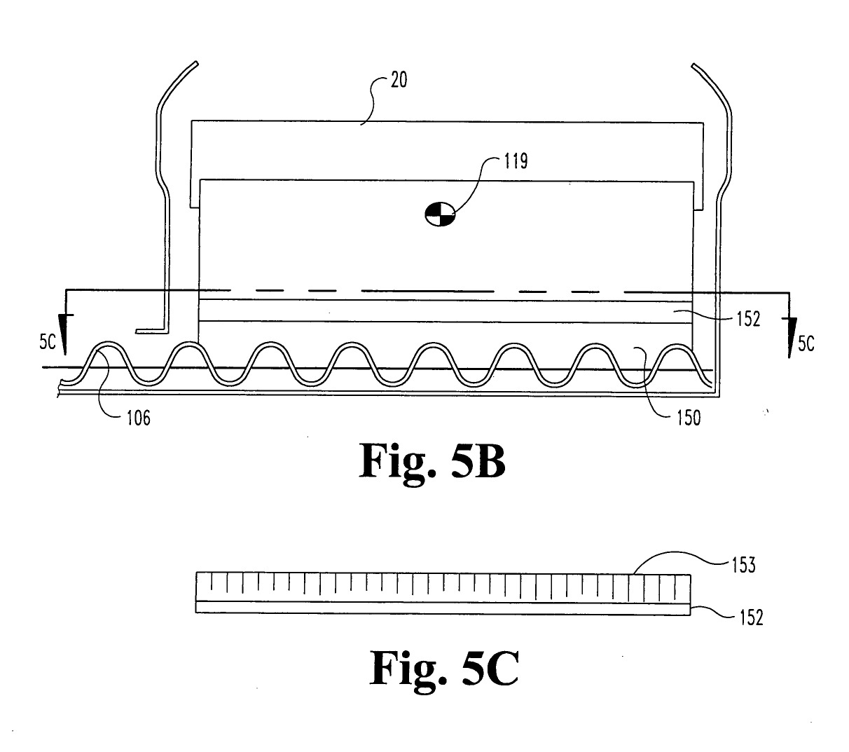

FIGS. 5-15 depict various embodiments of the present invention. Some of these drawings and their accompanying description use the numbering system previously established for a known combine 10. However, it is understood that these drawings and their description pertain to various embodiments of the present invention.

FIGS. 5A, 5B, and SC relate to one embodiment of the present invention as applicable to a combine 10.1. Combine 10.1 in one embodiment is the same as combine 10, but further includes first and second seals 150 and 152. Seals 150 and 152 are placed between the bottom of grain slide 102 and the bottom static structure of combine 10.1. Preferably, seals 150 and 152 are located aft of auger 106 and in front of auger 108. This placement of seals 150 and 152 discourages air from fan 129 from flowing as indicated by arrow 29.2. By discouraging flow in this pathway, and also discouraging this flow from flow path 109 between clean grain slide 102 and tailings pan 104, air flow from fan 29 is thereby encouraged to flow underneath shoe 28, as indicated by arrow 29.1.

Seal 152 is attached at one end to the underside of pan 102, and thereby pivots with shoe assembly 20. In one embodiment, seal 152 includes a flexible portion in contact with static seal 150, although other embodiments of the present invention include a flexible portion on static seal 150, or on both seals 150 and 152. Further, seals 150 and 152 are adapted and configured to accommodate the reciprocating motion of shoe assembly 20. For the seals shown in FIG. 5A, this accommodation is achieved by having a portion of seal 152 which has a lengthwise portion sized to remain in engagement with static seal 150 during all reciprocating motion. However, the present invention contemplates including a lengthwise section on static seal 150, or on both seals 150 and 152.

Referring to FIGS. 5B and 5C, seal members 150 and 152 preferably have a width that is generally as wide as shoe assembly 20. As best seen in FIG. 5C, seal member 152 includes an overlapping portion 153 which is preferably slit into a plurality of small flaps. As shoe assembly 20 rolls about axis 119, the slit nature of seal 152 provides for improved contact between seals 152 and 150.

In yet another embodiment of the present invention, a combine 10.2, which is the same as combine 10, except as shown and described differently herein, includes a static seal assembly 110.2. Seal assembly 110.2 is preferably attached to static structure of combine 10.2 in between augers 106 and 108. Static seal 110.2 preferably extends across the width of shoe 20, and is slit 5 into a variety of flaps, the spacing of the slits and the length of the flaps being adapted and configured such that substantially all of the flaps remain in contact with the underside of slide 102 during pivoting motion of shoe assembly 20.

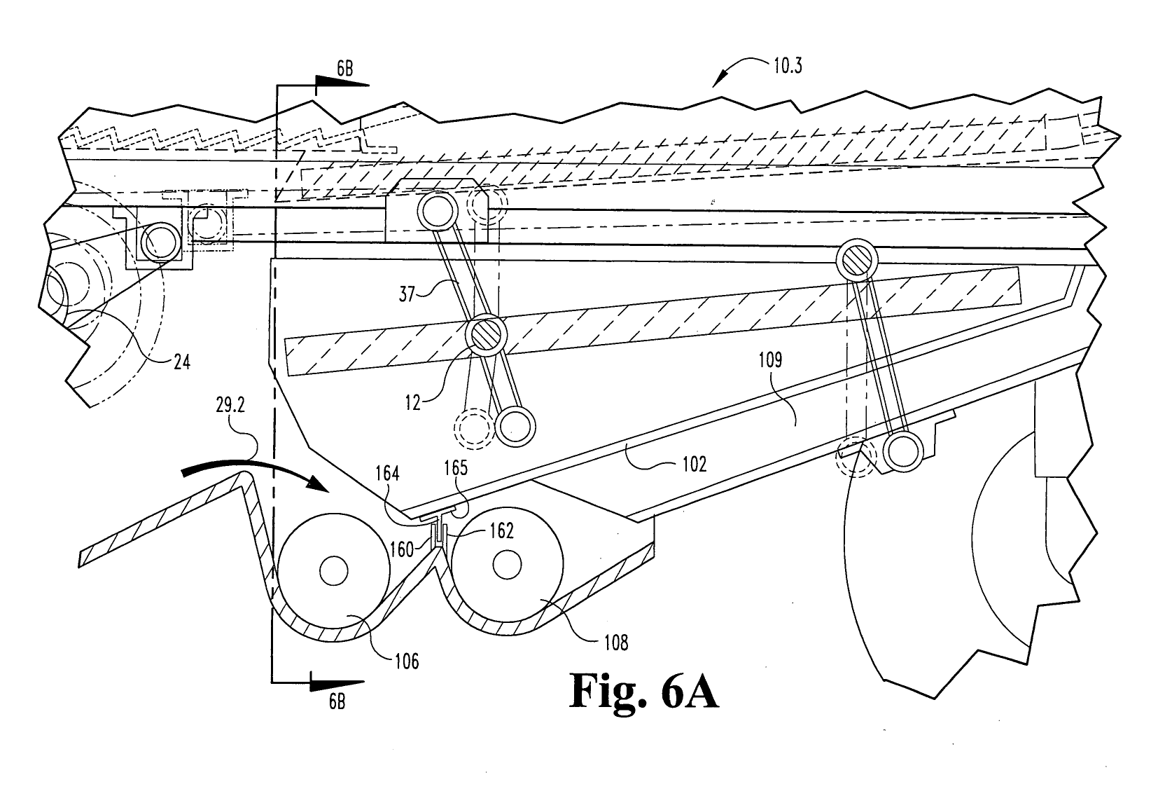

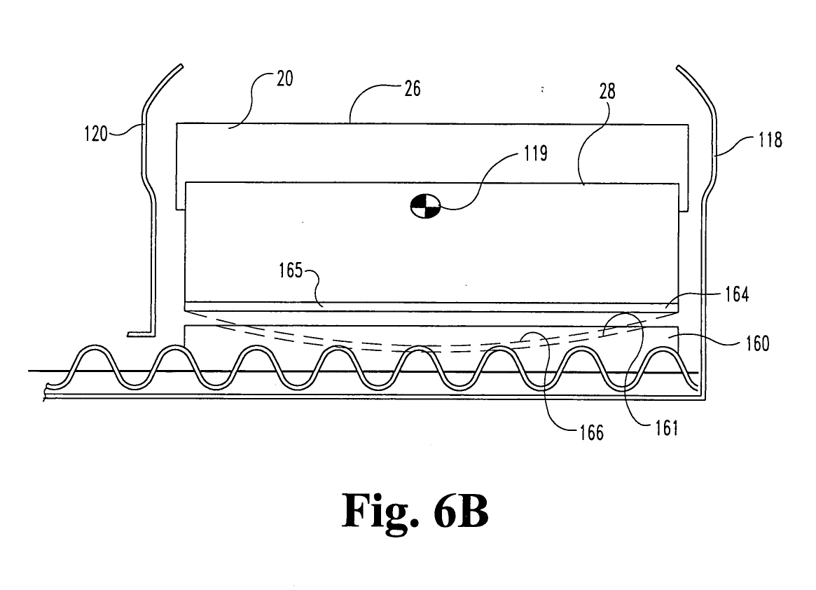

FIGS. 6A and 6B depict another embodiment of the present invention. Combine 10.3 includes a seal assembly comprising members 160, 162, and 164, preferably located between augers 106 and 108. Combine 10.3 is the same as combine 10, except for the differences shown and described herein.

A pair of seal members 160 and 162 are attached to stationary structure of combine 10.3, preferably aft of grain auger 106. Seal members 160 and 162 are generally parallel to one another and define a channel therebetween. A third seal member 164 is slidingly received within this channel. Seal member 164 includes a top portion 165 which in some embodiments of the present invention is in sliding contact with the underside of pan 102. In yet other embodiments, seal member 164 is attached to pan 102.

Referring to FIG. 6B, it can be seen that seal member 164 includes a portion 166 which extends within the channel and is rounded in shape. In some embodiments, this rounded portion 166 is received within a complementary-rounded channel 161 between seal members 160 and 162. Seal portion 166 and channel bottom 161 are adapted and configured to permit sliding contact of seal portion 166 within channel 161 without interfering with pivoting motion of shoe 20 about roll center 119. Thus, a substantial portion of seal portion 164 is within channel 161. As best appreciated by viewing FIG. 6A, this configuration includes that a portion of any air flowing along arrow 29.2 travels the circuitous path over first seal member 160, within the channel and around seal portion 166, and finally around aft seal member 162 before flowing into flow path 109. Thus, the assembly of seals 160, 162, and 164 discourage air from flowing within flow path 109.

Although what has been shown and described with regard to FIGS. 6A and 6B shows the channel-forming members being attached to the stationary structure of combine 10.3, the present invention also contemplates those embodiments in which the channel-forming members are attached to a portion of pivoting shoe assembly 20.

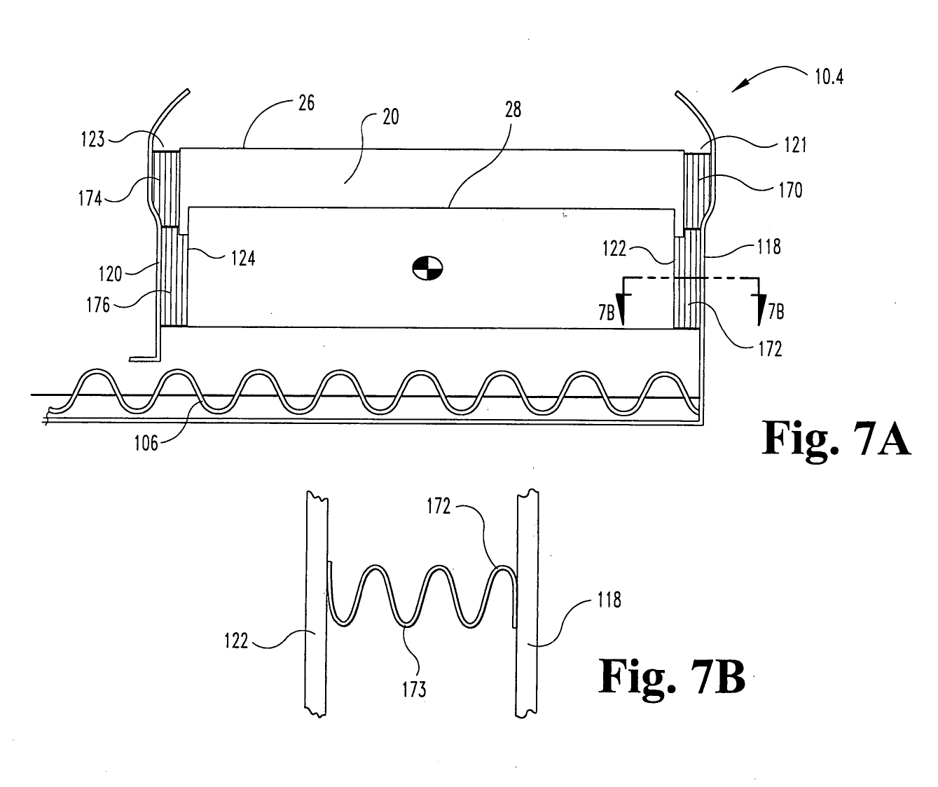

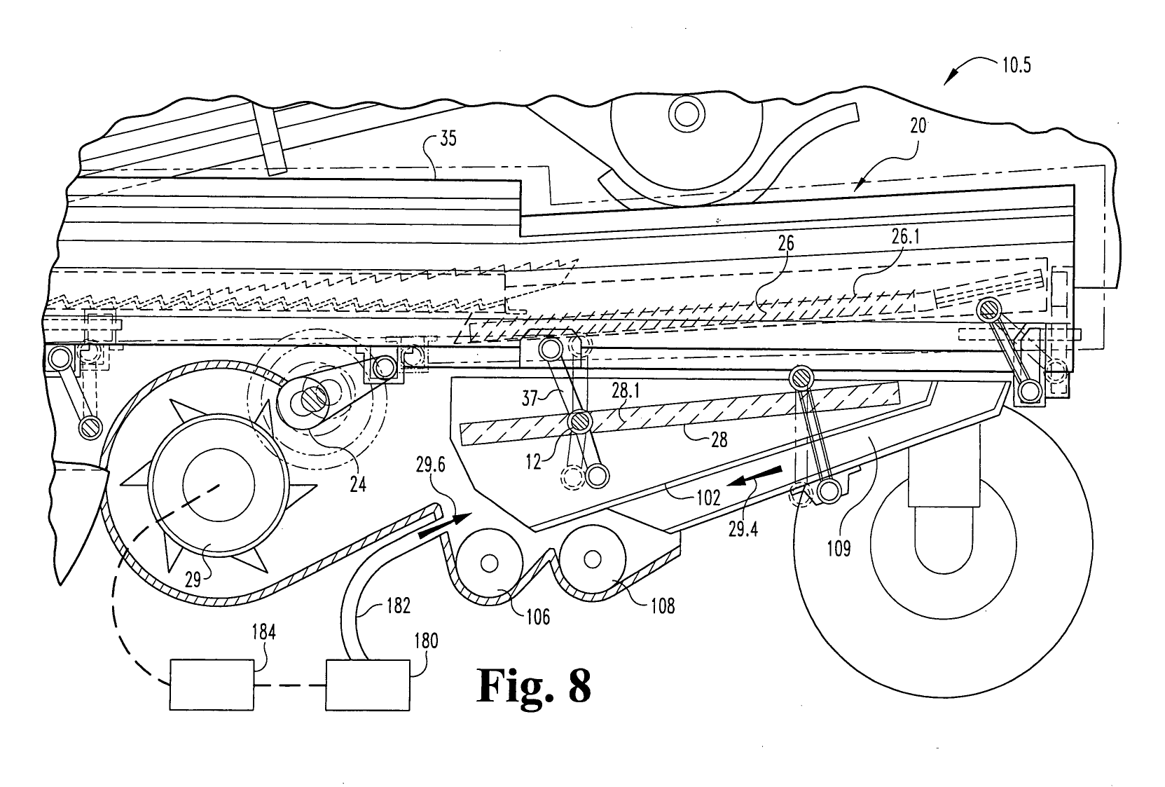

FIGS. 7A and 7B show portions of a combine 10.4 according to another embodiment of the present invention. Combine 10.4 is the same as combine 10, except that as shown and described differently herein.

Combine 10.4 includes at least one sealing member between a side of cleaning shoe 20 and the corresponding and proximate stationary structure of combine 10.4. As best seen in FIG. 7A, combine 10.4 preferably includes a plurality of flexible sealing members 170, 172, 174, and 176. Sealing members 170 and 174 seal the flowpath between the upper shoe assembly 26 and the adjacent stationary structure (the upper portions of stationary structure 118 and 120, respectively). In some embodiments, combine 10.4 further includes a pair of lower seals 172 and 176 which seal the flow path between the lower shoe and the corresponding adjacent stationary structure (the lower portions of walls 118 and 120, respectively).

Referring to FIG. 7B, a typical cross section of a side seal according to one embodiment of the present invention is shown. Seal member 172 preferably includes a plurality of convolutions 173 which extend in a fore and aft direction, so as to accommodate the reciprocating motion of the lower shoe. One end of seal member 172 is attached to stationary structure 118. The other end of seal member 172 is attached to a side 122 of shoe assembly 20 that is attached to lower shoe 28. Convolutions 173 are adapted and configured not only to accommodate reciprocating motion of shoe assembly 20, but also to accommodate pivoting motion. In one embodiment, convolutions 173 are formed from a flexible elastomeric material, which in some embodiments includes internal reinforcing wires, especially metal wires.

In one embodiment, seal 170 is located generally over seal 172; seal 174 is located generally over seal 176. As shoes 26 and 28 reciprocate in the alternating pattern previously described, gaps are formed at the interface between seal 170 and 172 and at the interface between seal 174 and 176. These gaps permit a slight flow of air. However, seals 170 and 172 are effective in discouraging flow along the right side of shoe 20 in flow path 121, and along the left side of shoe 20 in flow path 123. As the term “seal” is used herein, it is appreciated that complete sealing is not required.

Further, it is appreciated that the various embodiments of the invention described herein can be combined. For example, the side seals of combine 10.4 can be included with the bottom seals of combines 10.1, 10.2, and 10.3. Further, the present invention contemplates combining multiple bottom seal arrangements.

Referring to FIG. 8, a combine 10.5 according to another embodiment of the present invention is shown. Combine 10.5 is the same as combine 10, except for the differences shown and discussed hereafter. Combine 10.5 includes a second air blower or fan 180 which is connected by a duct 182 to direct a flow of air in the direction shown by arrow 29.6 between clean grain slide 102 and bottom sieve 28. In some embodiments, fan 180 provides a flow of air into shoe assembly 20 that is significant enough to entrain air within pathway 109 to flow as indicated by arrow 29.4.

In other embodiments of the present invention, the operation of blower 180 and fan 29 is controlled by an electronic controller 184, such as a digital computer. Controller 184 adjusts the speed of blower 180 in proportion to the speed of fan 29 so as to create the entrainment effect as previously described (i.e., to reverse the flow within pathway 109). In yet other embodiments, the speed of both fan 29 and blower 180 are controlled by electronic controller 184 in accordance with a sensor mounted to either slats 28.1 of lower shoe 28 or the slats 26.1 of upper shoe 26. It is known to adjust the position of slats 26.1 and/or 28.1 in accordance with the type of grain being harvested. In one embodiment, the selected angle of the slats is provided from a sensor operatively connected thereto. The sensor signal is provided to computer 184, which controls the speeds of fans 29 and 180.

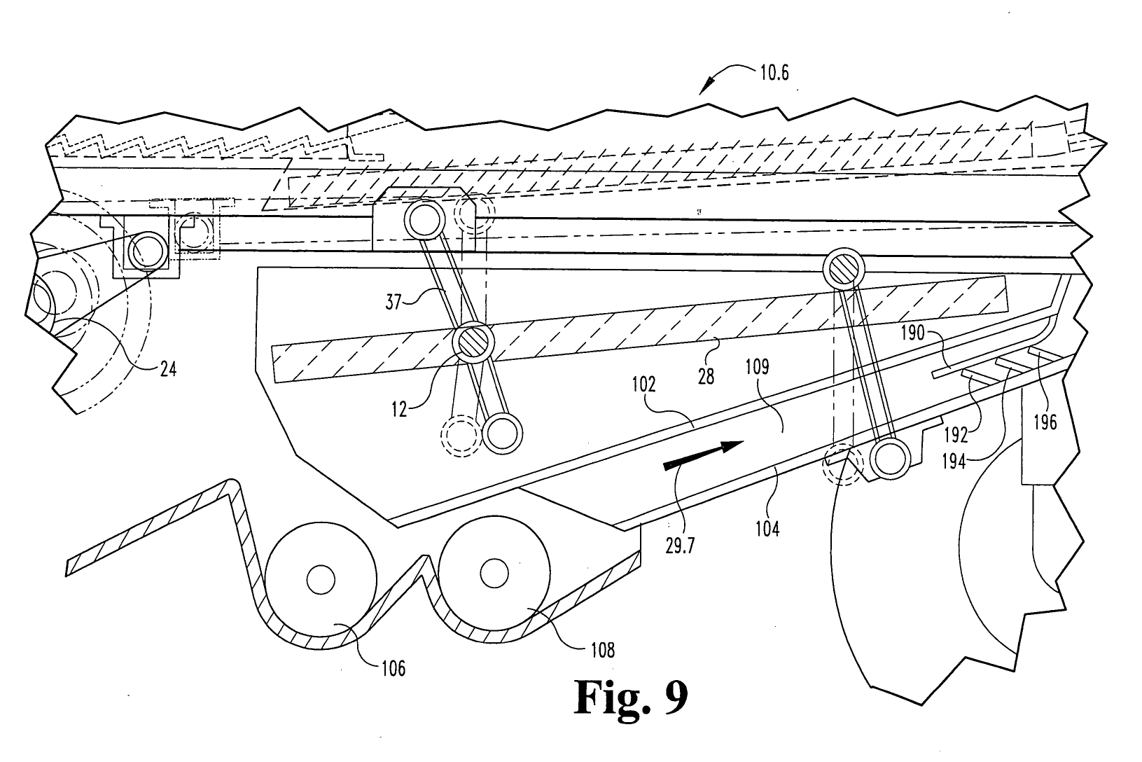

Referring to FIG. 9, a portion of a combine 10.6 according to one embodiment of the present invention is shown. Combine 10.6 is the same as combine 10, except for the differences shown and described herein. Combine 10.6 includes a flexible aft seal 190 which is attached at one end to clean grain pan 102. A flexible portion of seal 190 extends over a plurality of forward facing ridges or stationary ridges or slats 192, 194, and 196.

Seal 190 coacts with ridges 192, 194, and 196 to form a seal that discourages the flow of air in path 109 indicated by arrow 29.7 in pathway 109. However, slats 192, 194, and 196, and seal 190 are adapted and configured to permit the flow of tailings down the tailings pan 104 and into tailings auger 108. As seal 190 reciprocates back and forth because of its attachment with shoe assembly 20, the seal pushes tailings in a direction from slat 196 to slat 194, then to slat 192, and subsequently down into auger 108.

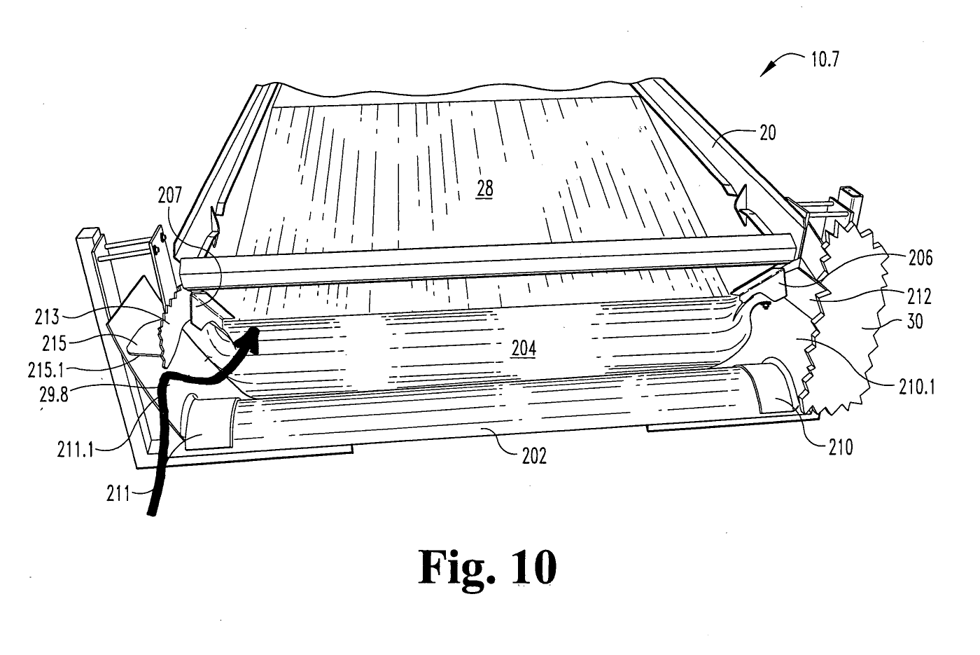

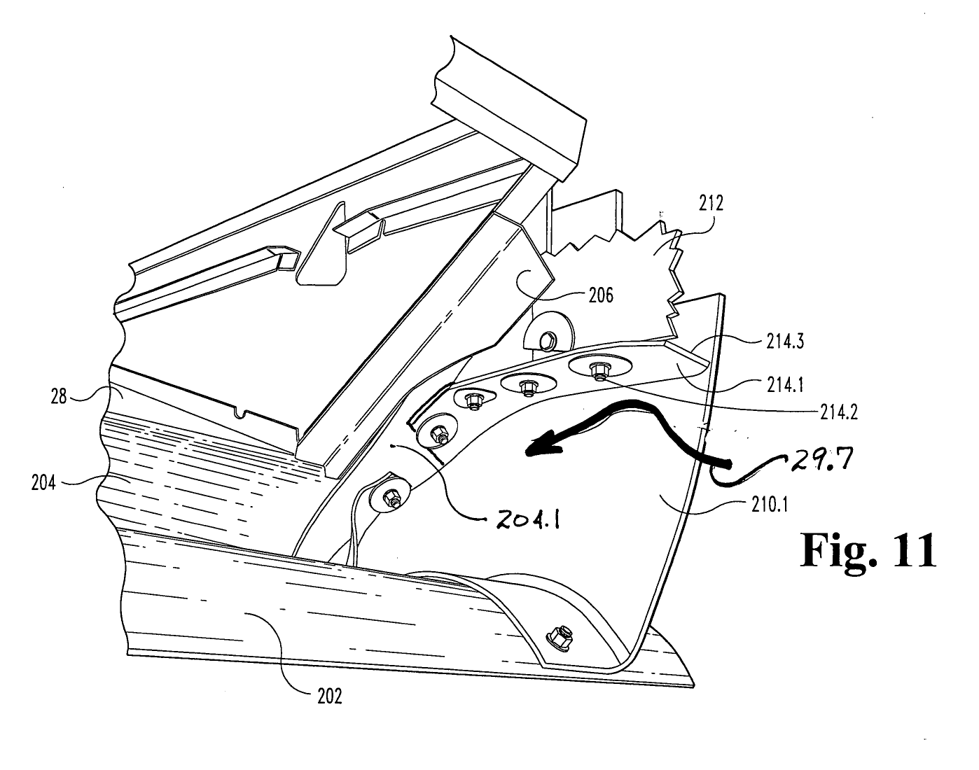

FIGS. 10-15 show a portion of a combine 10.7 according to another embodiment of the present invention. Combine 10.7 is the same as combine 10, except for the differences shown and discussed hereafter. FIGS. 10-14 have been made from photographs of hardware.

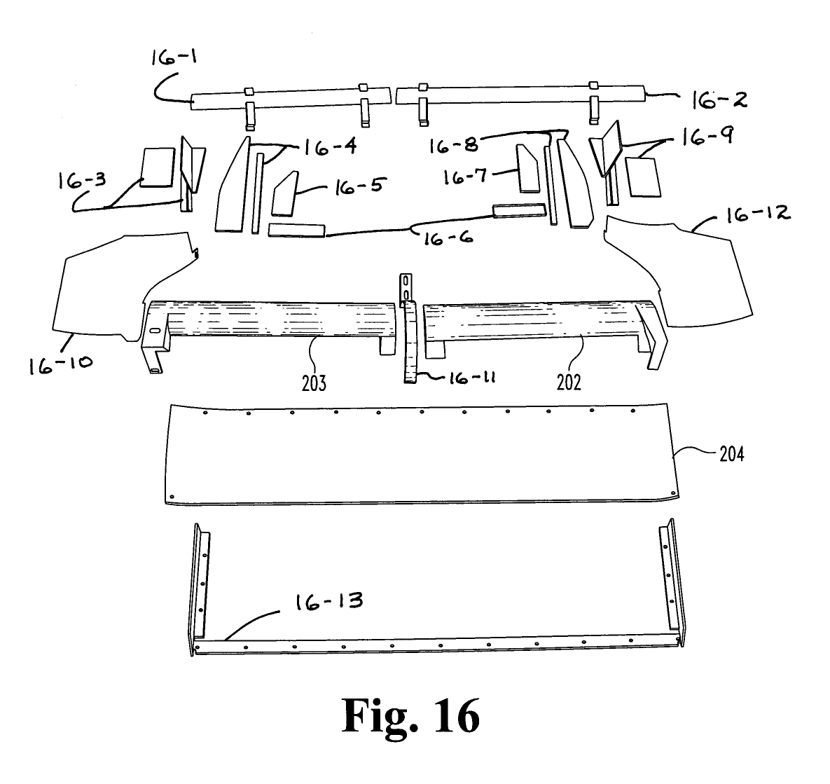

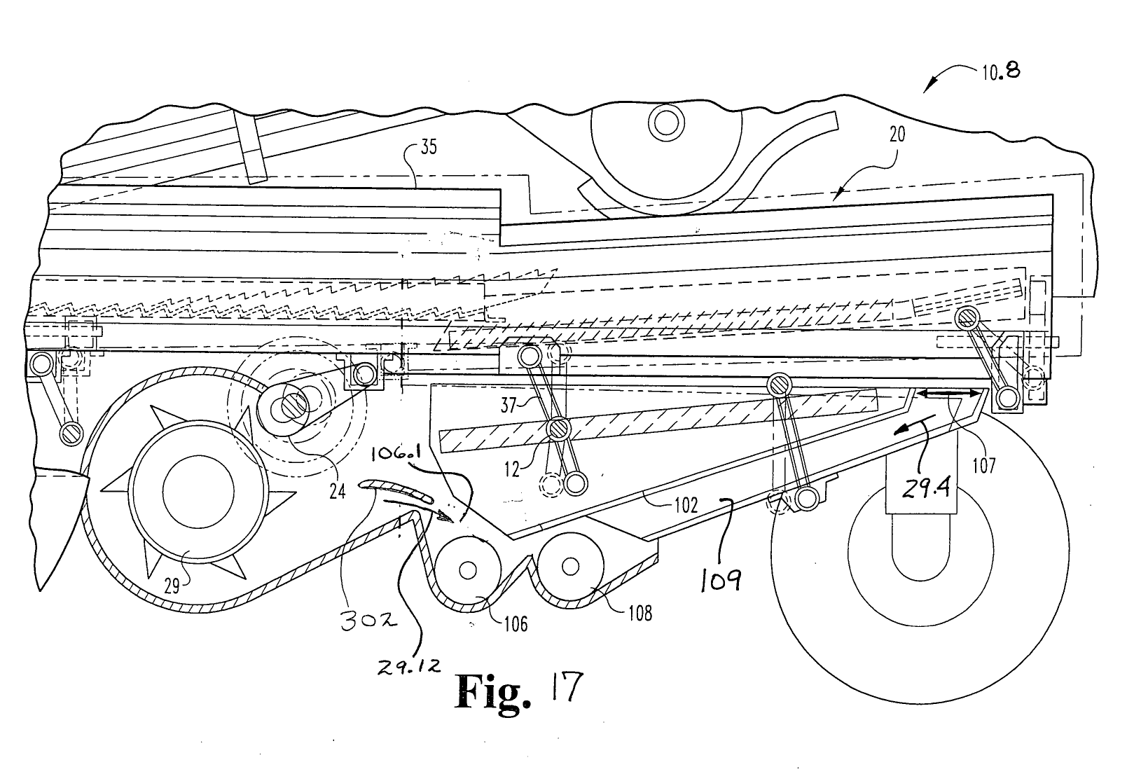

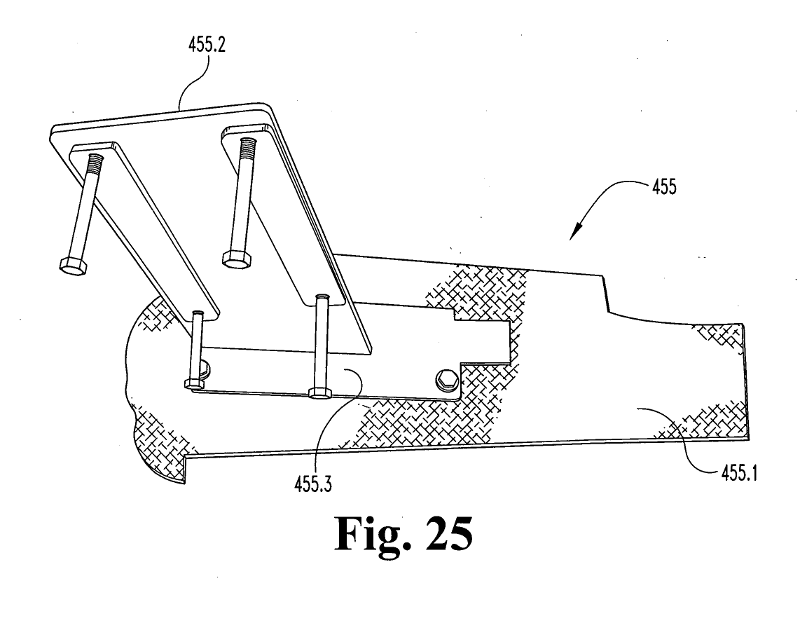

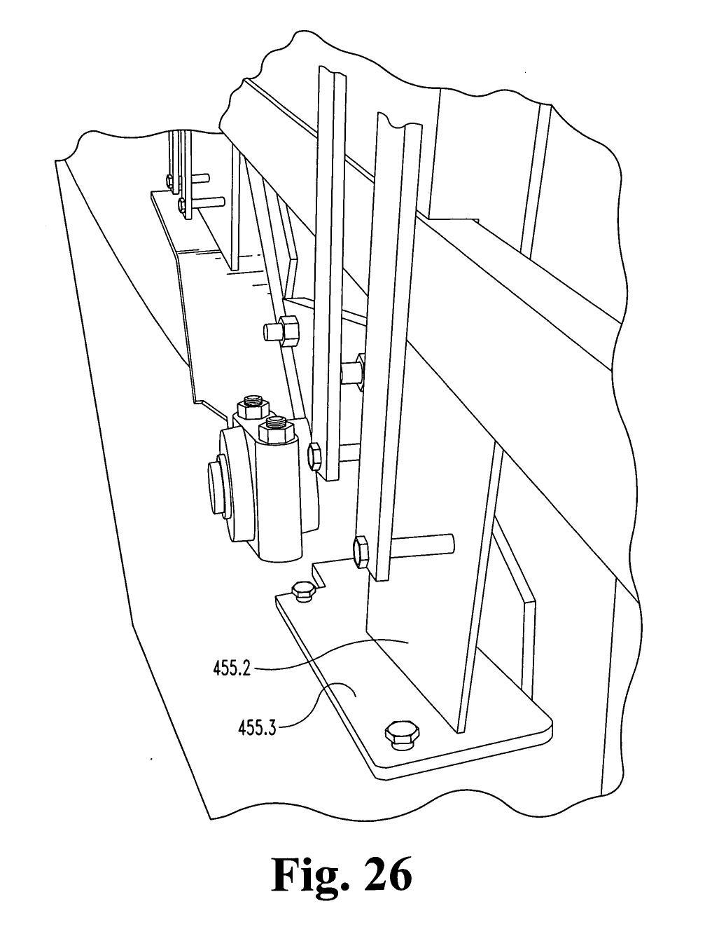

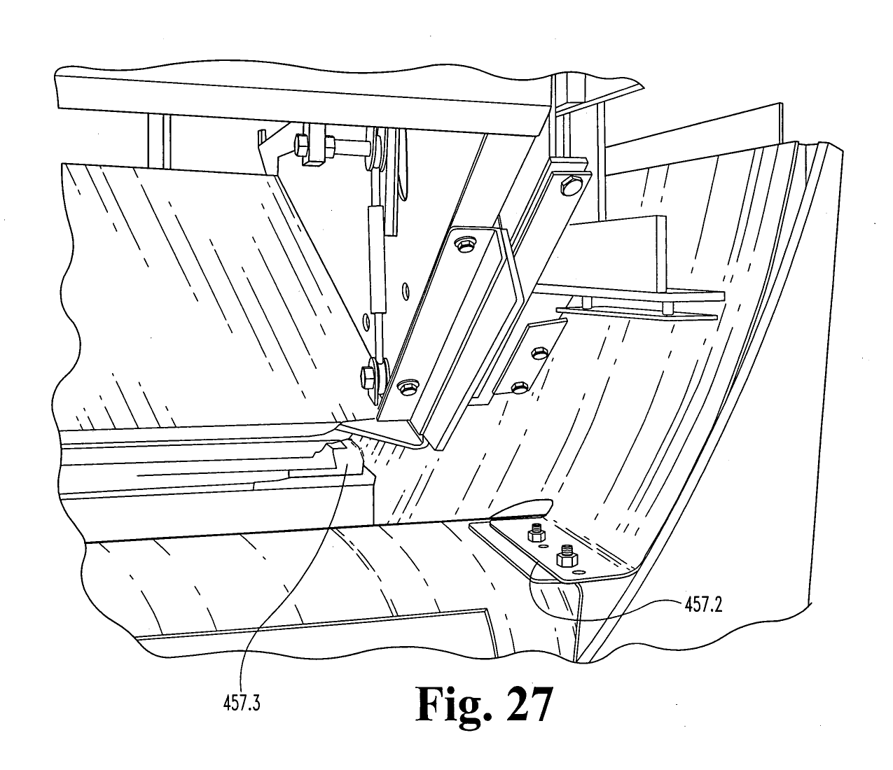

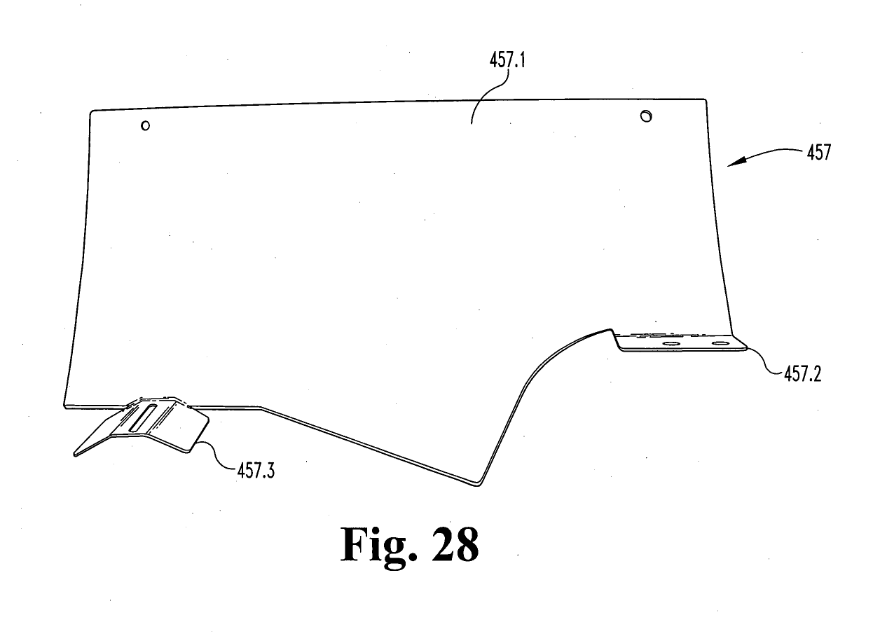

Combine 10.7 includes various components which can be incorporated on an existing combine in a kit of parts. In one embodiment of the present invention, there is a kit of parts for sealing a combine such as a New Holland CR960 combine, such as the kit shown and described with reference to FIGS. 10-15. However, the present invention is not so limited and the apparatus and principles described herein are applicable to any combine with a self-leveling shoe assembly. One embodiment of such a kit of parts is shown in FIG. 16. FIGS. 25-28 show portions of other sealing parts that can be added to the kit shown in FIG. 16. FIG. 25 shows a rear seal bracket assembly 455 comprising a flexible seal 455.1 attached to a steel plate 455.3, which in turn is welded to an attachment bracket 455.2. FIG. 26 shows seal assembly 455 as installed on a test article which includes portions of a self-leveling combine shoe. FIG. 28 is a plane view of a left seal assembly 457, which includes a sealing portion 457.1, which is attached to a first steel attachment bracket 457.2 at one end, and towards the other end attached to a rearward attachment bracket 457.3. FIG. 27 shows seal assembly 457 assembled into a test rig having portions of a self-leveling shoe from a combine. However, the present invention is not so limited, and another similar kit of parts will now be described.

Combine 10.7 includes a sheet metal auger cover 202 that is located generally over a portion of clean grain auger 106. Auger cover 202 is preferable mounted to the combine frame, and does not pivot with the self-leveling shoe.

Auger cover 202 supports on opposite sides right and left side stationary seals 210 and 211, respectively. Stationary seals 210 and 211 extend from the distal-most ends of auger cover 202 and include vertical portions 210.1 and 211.1 which extend upward toward the oscillating shoe assembly 20 and outward toward static structure of the combine 10.7. Both auger cover 202 and stationary side seals 210 and 211 do not roll with the rolling and self-leveling action of shoe assembly 20, but rather are preferably fixed in location relative to auger 107 and other portions of the combine frame. The vertical portions 210.1 and 211.1 extend both upwardly and outwardly, as best seen in reference to seal 211 in FIG. 10. The vertical and outward flaring portion 211.1 and 210.1 provide contacting surfaces for preferably flexible side pivoting seals 214 and 215, respectively. Side seal members 214 and 215 are attached to pivoting side seal support members 212 and 213, respectively. Support members 212 and 213 are attached to portions of shoe assembly 20 such that support members 212 and 213 roll about the longitudinal 5 axis of combine 10.7 as shoe assembly 20 rolls to maintain its level operation. Although seal support members 212 and 213 pivot with shoe assembly 20, they are fixed to the pivoting frame of the shoe assembly and therefore do not oscillate as these shoes reciprocate.

As best seen in FIGS. 10 and 11, flexible pivoting side seals 214 and 215 obstruct airflow from fan 29 that would otherwise flow into the right side and left side gaps 121 and 123, respectively. Referring to FIG. 10, arrow 29.8 represents a flow path for air being discharged from fan 29 which initially flows upward toward horizontal surface 215.1 of flexible seal 215, but is instead obstructed by seal 215, and therefore flows generally toward lower cleaning shoe 28. Referring to FIG. 11, arrow 29.7 depicts the flow of air exiting fan 29 and initially flowing upward toward the horizontal, spanwise portion 214.1 of flexible seal 214, the flow thereafter being redirected generally aft toward lower cleaning shoe 28.

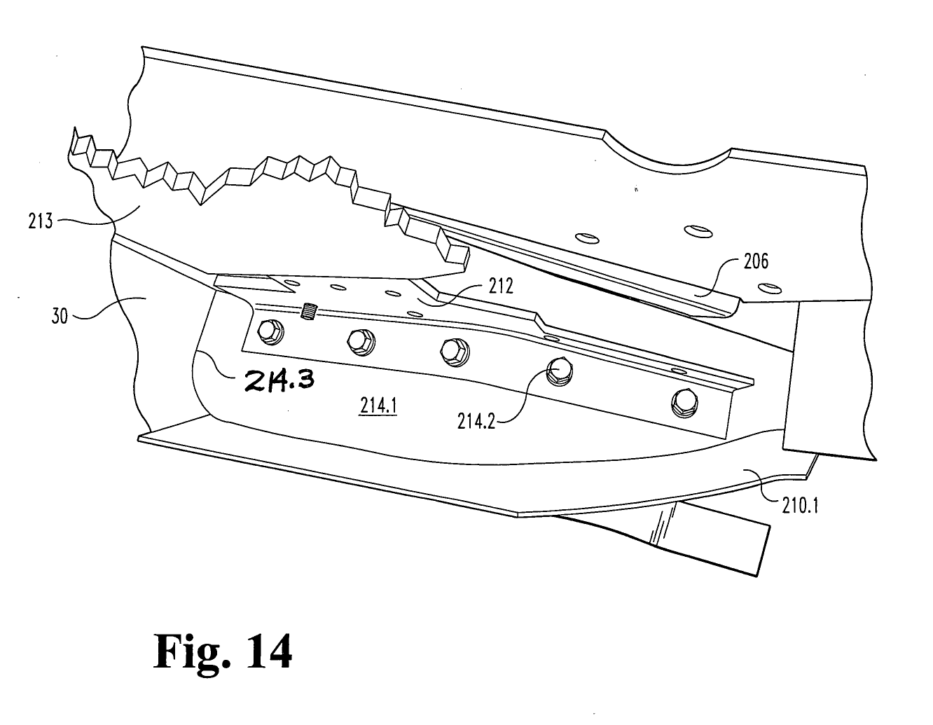

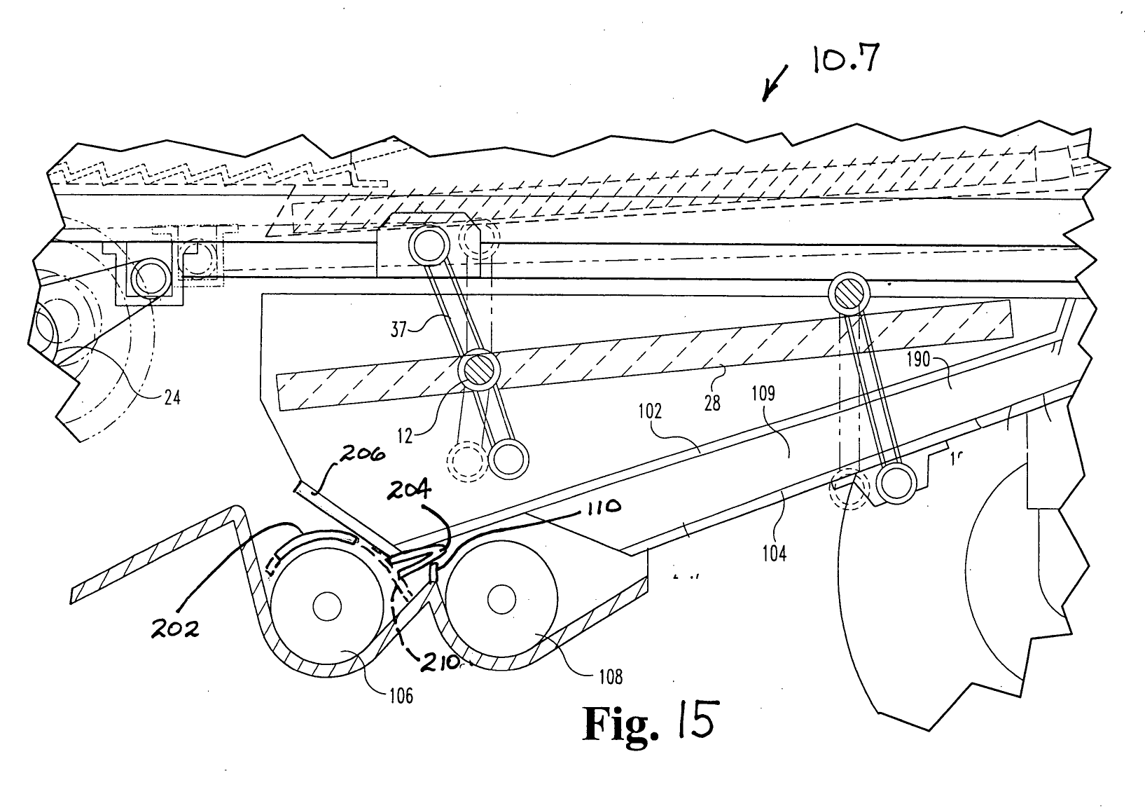

As best seen in FIGS. 11 and 14, the laterally-extending seal portions 214.1 and 215.1 are attached by a plurality of fasteners 214.2 and 215.2 (not shown), respectively, to pivoting side seal supports 212 and 213, respectively. However, the various embodiments of the present invention are not so limited. Pivoting flexible seals 214 and 215 can be attached in any manner to pivoting seal supports 212 and 213, respectively, including for instance by rivets or adhesive bonding as two examples. Further, although flexible seals 214 and 215 have been shown and described as pivoting as shoe assembly 20 pivots to maintain a level orientation, the present invention is not so limited. The present invention also includes those embodiments in which flexible lateral seals are attached to stationary structure, such as stationary seals 210 and 211. In these embodiments, the flexible seals would not pivot, but would maintain an obstruction to airflow which would otherwise go laterally around shoe assembly 20.

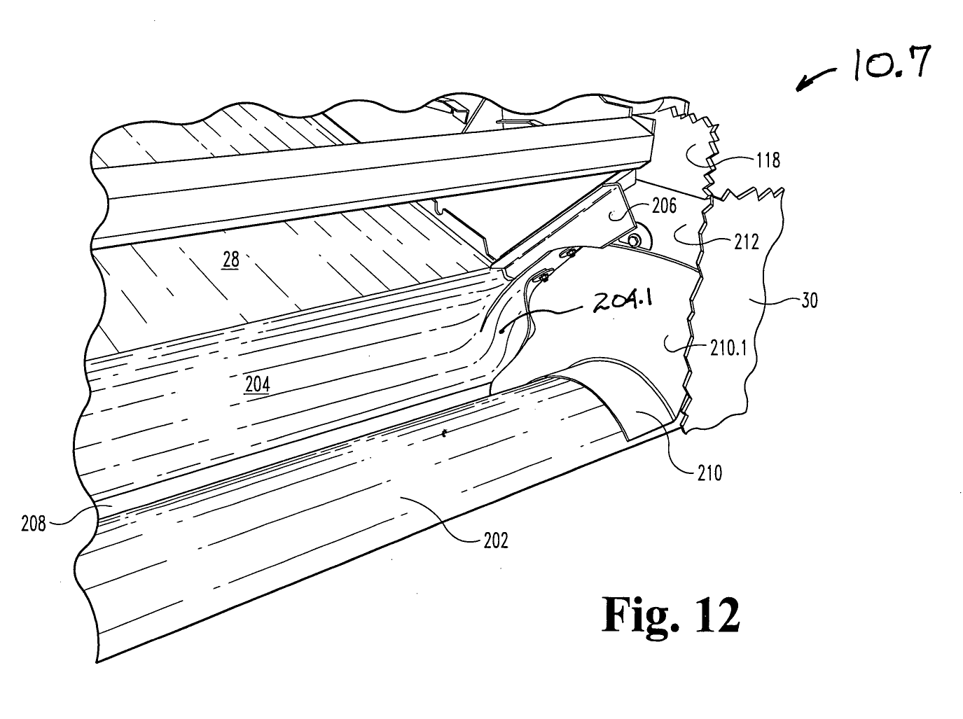

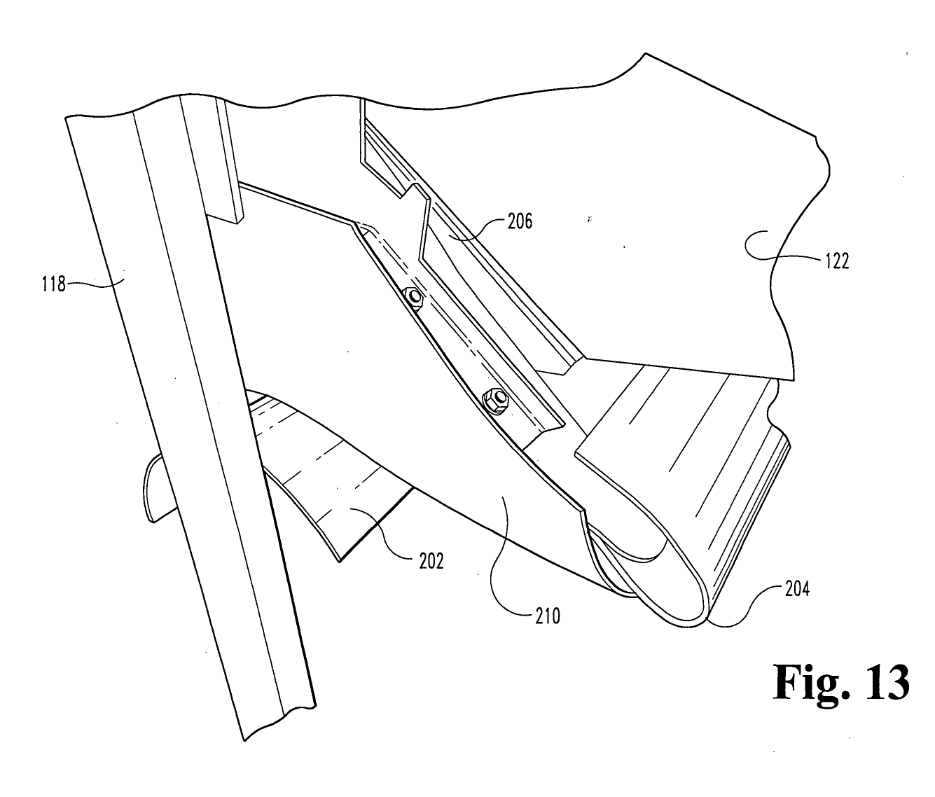

Referring to FIGS. 10, 12, and 14, combine 10.7 includes a cover 30 which at least partly houses fan 29. Flexible side seals 214 and 215 include forward portions 214.3 and 215.3 (not shown), respectively, which extend forward toward fan housing 30. These forward portions of the flexible side seals generally obstruct flow which would otherwise leak in front of the fan housing. Referring to FIG. 12, a portion 208 of the reciprocating shoe can be seen aft of auger cover 202 and in front of flexible seal 204.

In some embodiments of the present invention, combine 10.7 further includes a lower shoe flexible seal 204 as best seen in FIGS. 10, 12, and 13. Preferably, lower seal 204 is attached to lower cleaning shoe 28, and moves along with the self-leveling pivoting motion of the shoe and also moves with the reciprocating motion of the shoe. Lower shoe flexible seal 204 obstructs air from flowing under shoe 28.

Flexible lower seal 204 extends generally across the width of shoe 20. Seal 204 is supported at the right and left sides by shoe extension attachment members 206 and 207, which in one embodiment are sheet metal brackets which are attached to lateral sides of the shoe assembly. In addition, in one embodiment, seal 204 is attached to the underside of shoe assembly 20 across the width of the shoe.

As best seen in FIG. 15, in one embodiment seal 204 is of sufficient length to fold over and contact a portion of the combine in-between augers 106 and 108, such as static seal 110. FIG. 15 also illustrates the placement of auger cover 202 relative to auger 106, and also illustrates how side stationary shoe 210 is positioned relative to auger 106.

As best seen in FIGS. 11 and 12, in some embodiments lower seal 204 includes a slack portion 204.1 which extends upward and forward from seal 204 toward an interface with the upper aft surface of side stationary seal 210. As best seen in FIG. 11, this flap 204.1 of seal 204 is attached to pivoting side seal support 212 by one or more fasteners 214.2. The slack or looseness in flap 204.1 permits one portion of seal 204 (generally spanwise across the width of shoe 28) to reciprocate with shoe 28, and another portion of the seal (flap 204.1) to be attached to a pivoting but non-oscillating structure (pivoting seal support 212).

A self-leveling shoe in a combine harvester provides for a rolling movement of the shoe assembly relative to the longitudinal axis of the combine and within the frame of the combine. As the combine moves through the field and experiences uneven terrain such that the left/right orientation of the combine is no longer level, the shoe is able to react in an opposite motion to the frame, thereby maintaining a properly oriented surface within which to clean the grain. While the self-leveling feature provides some advantages and efficiencies, control of the air within the shoe can be been problematic for several reasons. The air can escape to the outside of the combine and the air can move within the shoe by recirculation from one area to another.

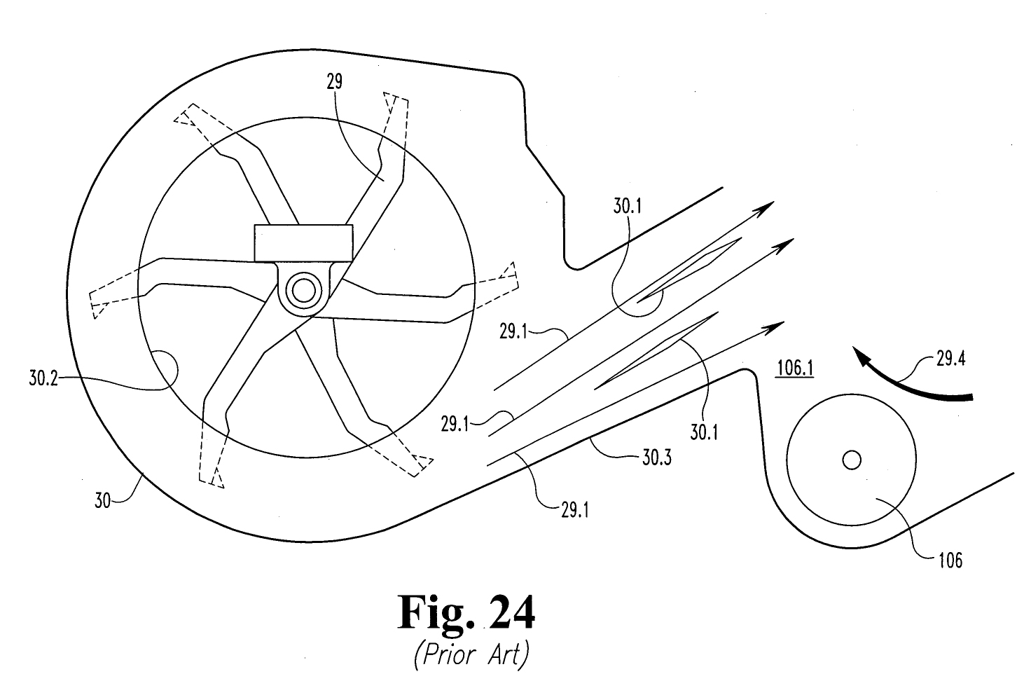

The phenomenon of recirculating air flow in a self-leveling shoe such as in a New Holland CR970 combine could be caused by entrainment or a Venturi Effect that is created by the way the air leaves the fan outlet 30.3. FIG. 24 illustrates the geometry of the fan housing 30, windboards 30.1 and the air stream 29.1 of fan assemblies used in some combines. Air is provided to a fan inlet 30.2 of fan housing 30. As viewed in FIG. 24, fan 29 rotates in a counterclockwise manner and pushes air out through fan housing outlet 30.3. As the air is pushed out by the rotating fan 29, the air encounters windboards 30.1 designed to direct the air toward the sieves. Windboards 30.1 and outlet 30.3 coact to direct exiting air 29.1 along a plurality of generally parallel streamlines.

As is well known from application of Bernoulli's principles, the movement of air along a streamline results in a decrease in the static pressure of that air as measured perpendicular to the streamline. Referring to FIG. 24, the inlet area 106.1 proximate to clean grain auger 106 immediately downstream of the fan exit 30.3 is exposed to this decreased static pressure. If the static pressure is low enough (i.e., if the velocity along the streamline is high enough), the lower static pressure existing in area 106.1 can entrain air from any source of higher pressure, including from under the clean grain pan as indicated by airflow 29.4. This airflow 29.4 is a recirculating airflow from the aft of the shoe assembly toward the fan outlet 30.3.

As the air leaves the fan 29 and the lower static pressure is produced perpendicular to the wind boards and at the fan housing floor, air is entrained in from any available source of higher pressure air. As described above, air can be entrained from the aft of the shoe assembly, from underneath the clean grain auger, or from the sides of the air housing 30, as some examples. As another example, air preparing to exit the combine after passing around upper sieve 26 can slow down (and thus have an increased status pressure) near the end of the shoe assembly prior to exiting the combine. Based on flow visualization testing performed with smoke, some of this higher pressure air reverses direction and instead of exiting the combine, travels under the clean grain pin 102 as indicated by arrow 29.4, FIG. 8. It is possible that there are other re-circulating paths within the combine. One impact of this recirculation is that the flow characteristics of the air intended for efficient cleaning of the grain at the top sieve are changed and cleaning efficiency is reduced.

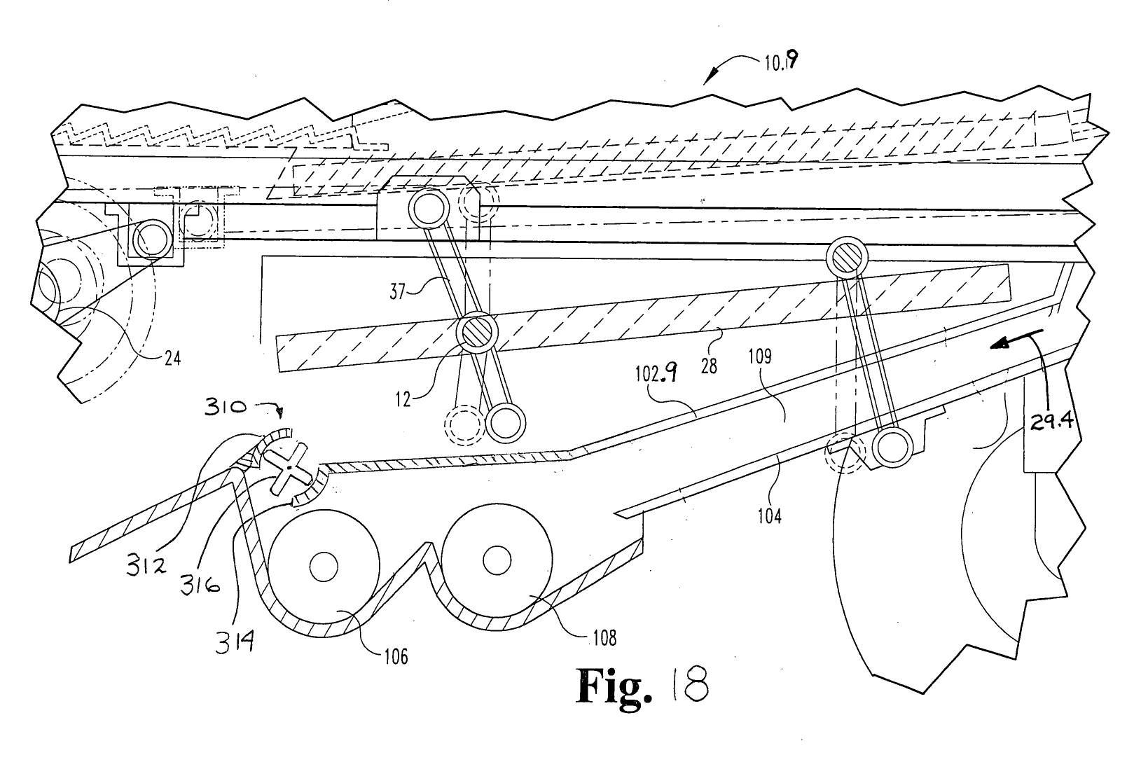

FIG. 17 is a cutaway, side elevational view of a portion of a combine 10.8 according to another embodiment of the present invention. Combine 10.8 is generally similar to the other inventive combines described herein, except for the addition of one or more air deflectors 302 (shown in cross section). Air deflector 302 is adapted and configured to turn an out flowing streamline 29.1 (as shown in FIG. 24) and redirect it into an air streamline 29.12 flowing toward area 106.1 proximate to clean grain auger 106. Preferably, air deflector 302 extends laterally across combine 10.8 for a substantial portion of the width of the shoe assembly. In some embodiments, combine 10.8 includes other deflectors which continue the guiding of streamline 29.12 to force at least a portion of that air to flow within the flowpath 109 underneath clean grain pan 102.

This deflection of fan air toward the clean grain auger and under the clean grain pan can reduce or eliminate the reverse circulation of air as indicated by arrow 29.4. Deflector 302 provides air to the lower part of the shoe that will not be supplied to the sieve area. Therefore, the reduced air available to the sieve can be replaced by adjusting of speed of fan 29, thereby maintaining proper airflow to the sieves and simultaneously reducing or eliminating recirculation from the aft of the shoe assembly.

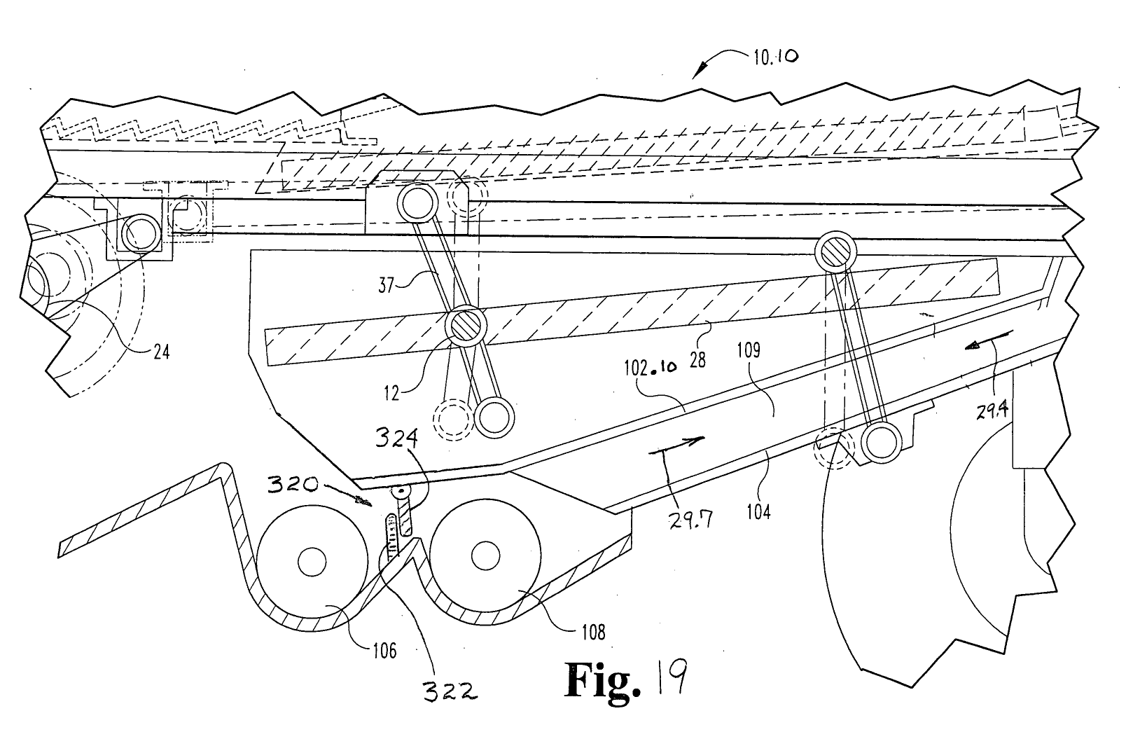

FIG. 18 shows a cutaway, side elevational view of a combine 10.9 according to another embodiment of the present invention. Combine 10.9 is generally similar to the other inventive combines described herein, except for the changes now described. Combine 10.9 includes an airlock assembly 310.

Airlock assembly 310 preferably extends across most of the width of clean grain pan 102. In one embodiment, the airlock assembly includes a static sealing member 314 which extends from a clean grain pan 102.9, a second static sealing member 312 which extends from the floor of the combine, and a movable member such as rotating member 316 located therebetween. In combine 10.9, rotating member 316 is adapted and configured to maintain an obstruction or seal to the movement of air from the fan housing toward the clean grain auger 106, which at the same time permitting the flow of clean grain from the clean grain pan 102.9 toward the clean grain auger 106.

Rotating member 316 preferably includes four symmetric projections which extend from the rotational centerline outward toward the inner sealing surfaces of static members 312 and 314. Rotating member 316 is preferably driven to rotate by a motor (not shown). Rotating member 316 coacts with static members 312 and 314 in a manner analogous to a revolving door to a building. As clean grain falls upon pan 102.9, the clean grain moves forward under the influence of gravity toward rotating member 316. In one embodiment, member 316 rotates in a counter clockwise direction as shown in FIG. 18. As the clean grain continues its slide along pan 102.9, the grain is caught on one of the projections of rotating member 316. As member 316 continues its clockwise rotation, the grain slides along the inner curved surface of member 314 and finally is emptied into auger 106.

The circumferential extent of static members 312 and 314 is such that as the grain is emptied into the auger, other projections of member 316 maintain a sealing or air-obstructing contact with member 312 and 314. In this way, airlock 310 impedes the fluid communication from the aft of the shoe assembly, along pathway 109 under clean grain pan 102.9, toward clean grain auger 106. In this manner, the extent of re-circulated flow as indicated by steam line 29.4 is reduced or eliminated.

FIG. 19 is a cutaway, side elevational view of a portion of a combine 10.10 according to another embodiment of the present invention. Combine 10.10 is similar to the other inventive combines disclosed herein, but also includes an apparatus for permitting airflow from the area proximate to auger 106 toward the aft of combine 10.10 (as indicated by arrow 29.7), but discouraging the reverse flow of direction along that same path (as indicated by arrow 29.4).

Combine 10.10 includes a one-way valve or flapper valve 320 preferably located inbetween augers 106 and 108, although the present invention also contemplates placement of valve 320 aft of auger 108. Valve 320 includes a lower static portion 322 attached to the bottom of combine 10.10. A hinged movable seal member 324 is located proximate to member 322, and as shown in FIG. 19 can be connected to the underside of a clean grain pan 102.10. Valve 320 preferably extends across the width of the shoe assembly. In some embodiments, movable sealing portion 324 is biased to remain in contact with static seal member 322, such as by the action of springs or gravity (i.e., the weight of member 324 maintains it in contact with member 322).

As the two members are shown in FIG. 19, air flowing from the left (from fan 29) is able to move hinged member 324 out of sealing contact with member 322, thereby providing a path for the flow of air as indicated by arrow 29.7. Air from the fan should be of a velocity high enough to overcome any biasing force which maintains hinged member 324 in contact with member 322. However, valve assembly 320 is a one-way valve, such that air flowing along the path as indicated by arrow 29.4 will impact against hinged member 324 and act to push member 324 in sealing contact with member 322. Therefore, flow of air as indicated by arrow 29.4 is discouraged by valve 320.

While several methods and apparatus for eliminating the recirculation around the shoe have been shown and described, other embodiments of the present invention pertain to other apparatus and methods such as additional blowers to control the movement of air within a self-leveling shoe.

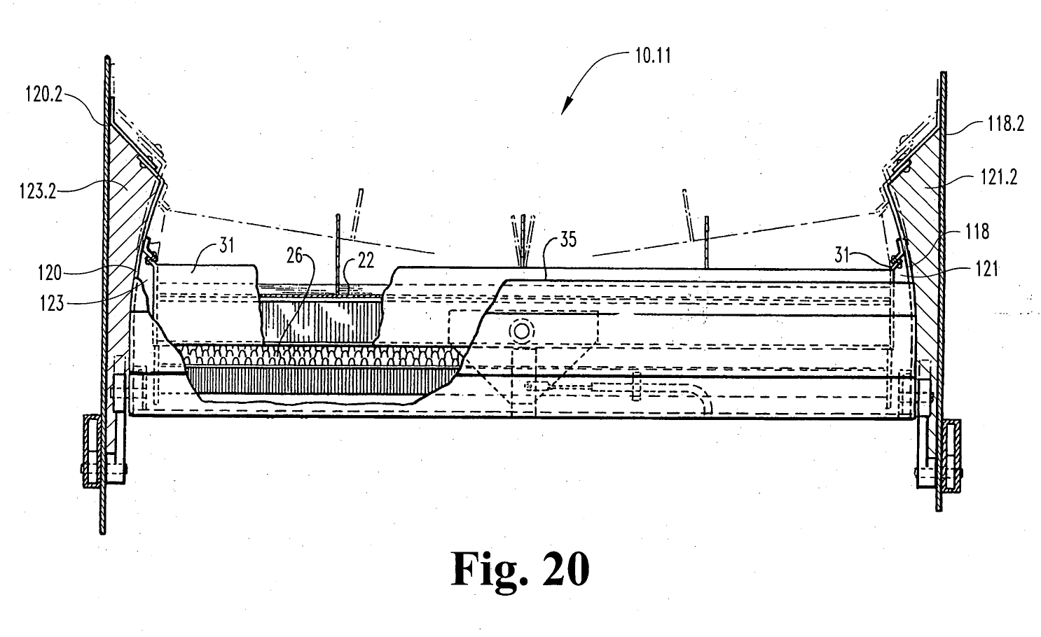

As one example, the impact of the location of the fan, as well as wind from ambient conditions of the combine are able to negatively affect the operation of the self-leveling shoe. These forces can impact the cleaning of grain by affecting the flow of air within the shoe. FIG. 20 shows a cross sectional front view of a combine 10.11 according to another embodiment of the present invention. The view of FIG. 20 also shows the general flow path for air exiting fan 29 from housing outlet 30.3 flowing toward the shoe assembly. In some self-leveling combines, there are inner walls 118 and 120 which face the self-leveling shoe assembly therebetween. In some embodiments, these walls are curved to provide uniform clearance between the shoe and these inner walls 118 and 120 as the shoe assembly rolls along the combine longitudinal axis. In some embodiments, there is a corresponding outer wall 118.2 and 120.2, respectively, which can be attached to the corresponding inner wall 118 or 120. This combination of inner and outer walls can form therebetween a gap or space 121.2 or 123.2, respectively.

In one embodiment of the present invention, seals 121.3 and 123.3 are provided between the inner and outer static walls on either side of the self leveling shoe, as indicated by the cross hatched areas of FIG. 20. This sealing can be accomplished by static panels placed between walls 118.2 and 118, as one example. Alternatively, the area between walls 118.2 and 118 can be made more obstructive to airflow by filling all or some of the volume between the walls with a flow obstructing material, such as fiberglass. In other embodiments, there can be a flexible flap of material that extends across from the outer wall to the inner wall such as a section of rubber sheet. In yet other embodiments the inner and outer walls (118 and 118.2; 120 and 120.2) are adapted and configured to include transitional members that obstruct the gaps that would otherwise exist therebetween.

In one embodiment of the present invention there are apparatus and methods to minimize the impact of the ambient wind as well as the mechanically induced influences by sealing off the area exposed at the front and rear of the shoe assembly which are typically exposed. Additionally, some embodiments of the present invention pertain to methods which can provide relief of efficiency loss by outside influences. Some of these methods are, but are not limited to, relocation of the fan intake area by use of ductwork, closing off access holes in the frame of the combine by seals and covers, and use of blowers to provide air movement which counters influences which otherwise would harm cleaning efficiency.

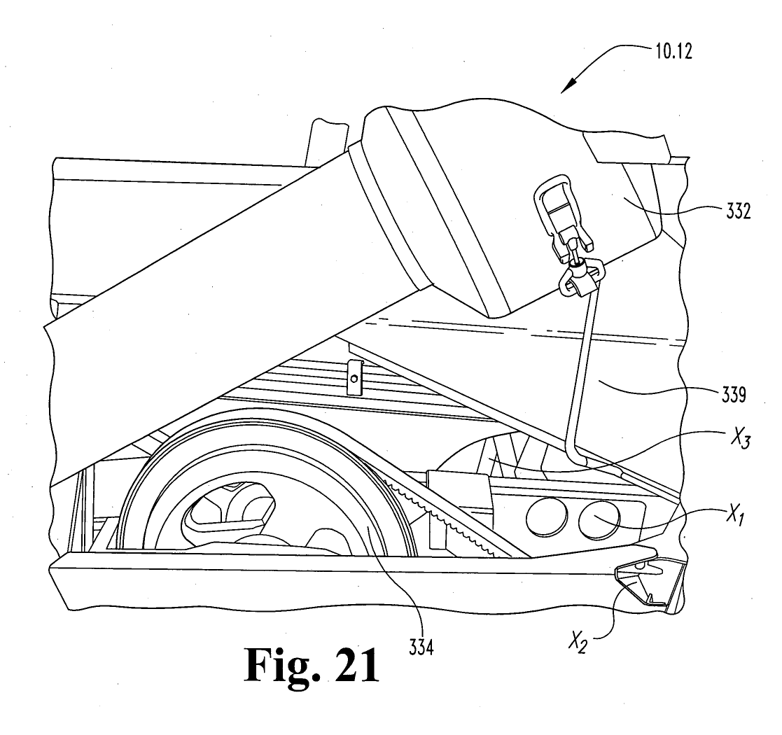

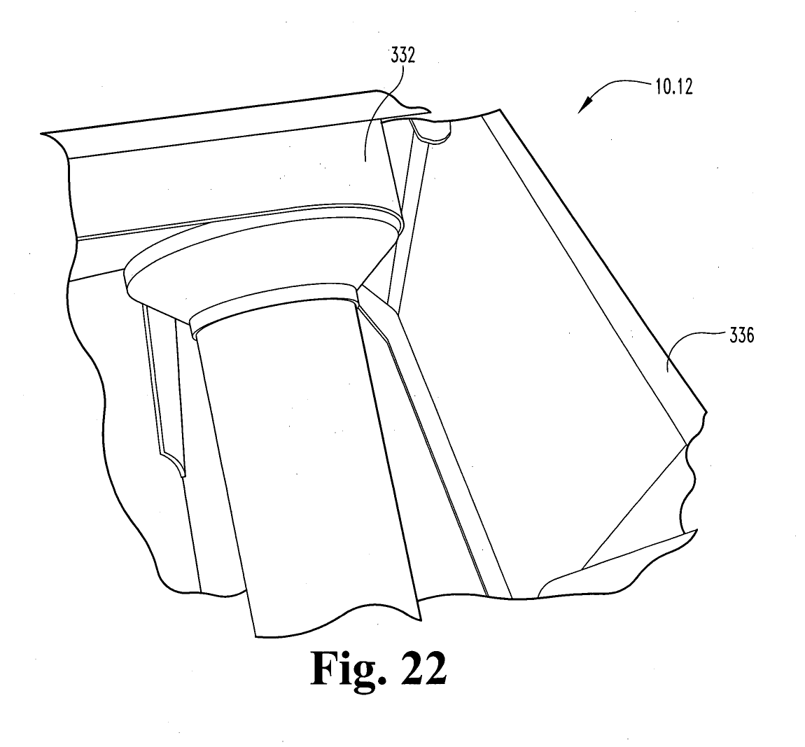

FIGS. 21 and 22 relate to a combine 10.12 according to another embodiment of the present invention. FIG. 21 is a side elevational photograph of a New Holland CR970 combine, as viewed with door 336 removed, and from the vantage point of door 336 (see the position of door 336 in FIG. 22). FIGS. 21 and 22 show auger blower 332, pulley 334 which drives fan 29 through a belt, tire shield 339, and various flow apertures X1, X2, and X3 which are in fluid communication with fan inlet 30.2. It is believed that the area shown in FIGS. 21 and 22 is generally lower in pressure than ambient, and provides air to the fan inlet. In one embodiment of the present invention, the supply of air to this region of the combine 10.12 is augmented by placing flow apertures, such as holes or slats, in door 336 to increase the amount of air being provided by fan 29 (and thereby reducing the inlet restriction to the fan).

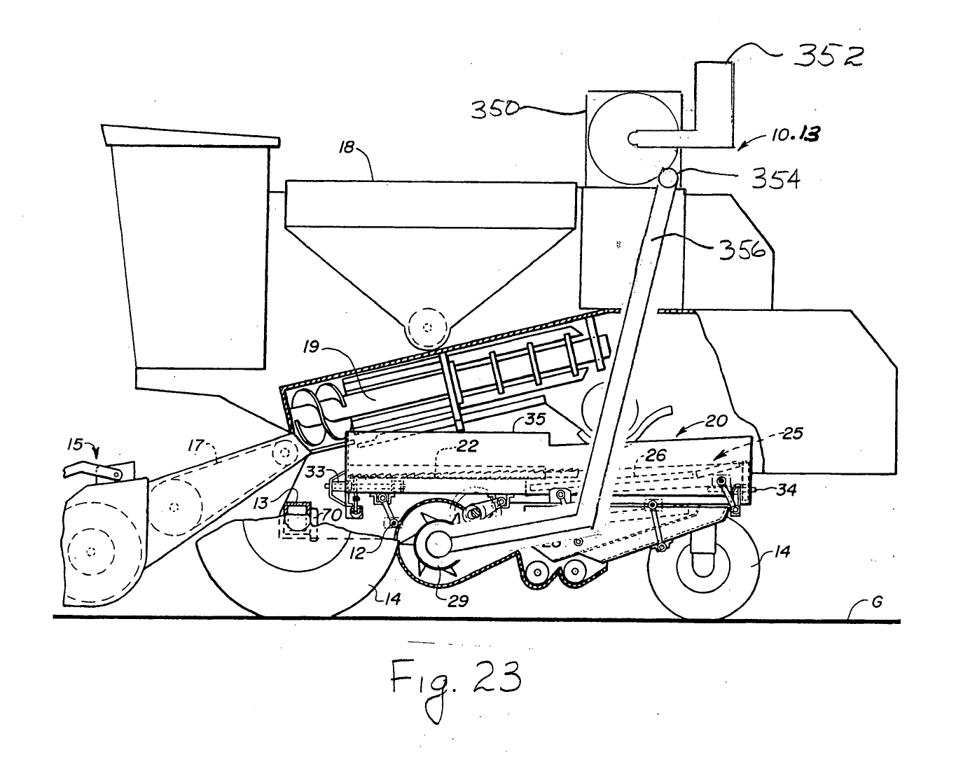

FIG. 23 depicts a combine 10.13 according to another embodiment of the present invention. Combine 10.13 includes an additional fan 350 which provides additional air to the inlet of fan 29. Fan 350 includes a preferably upward facing inlet 352 and an air outlet 354 which provides air to a duct 356 which is in fluid communication with fan inlet 30.2.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for separating grain, comprising:
providing a combine including a shoe assembly having at least one reciprocating sieve, an auger, and a fan for blowing air;
blowing air from the fan toward the shoe assembly;
permitting grain to move from the sieve into the auger; and
substantially obstructing the blown air from contacting the auger.

2. The method of claim 1 wherein said providing includes a movable member placed between the sieve and the auger, the combine includes a frame, and said permitting is by moving the member relative to the frame.

3. The method of claim 1 wherein said moving is by rotating the member relative to the frame.

4. The method of claim 1 wherein the combine has a longitudinally axis and the shoe assembly is pivotable about to the longitudinal axis.

5. The method of claim 1 wherein the shoe assembly is self-leveling including an upper sieve and a lower sieve.

6. An apparatus for separating grain, comprising:
a combine including a shoe assembly having at least one reciprocating sieve, an auger adapted and configured for receiving the harvested product from said sieve, and a fan having an outlet for blowing air toward said shoe assembly; and
an air deflecting member placed between the outlet and said auger, said member being adapted and configured for directing air from the outlet toward said auger.

7. The apparatus of claim 6 wherein said combine includes a pivoting self-leveling shoe assembly having an upper sieve and a lower sieve,

8. The apparatus of claim 6 wherein said member is adapted and configured for not directing air toward said shoe assembly.

9. The apparatus of claim 6 wherein said member has a curved cross sectional shape.

10. An apparatus for separating grain, comprising:
a combine including a pivoting self-leveling shoe assembly having at least one movable sieve;
a fan for blowing air toward said shoe assembly;
an auger adapted and configured for receiving the harvested product from said sieve, said auger being received within a recess of said combine; and
a cover placed above said auger, said cover spanning at least a portion of the length of said auger within the recess, with at least some of the air blown from the fan flowing over said cover.

11. The apparatus of claim 10 wherein said cover substantially spans the length of said auger within said recess.

12. The apparatus of claim 10 wherein said shoe assembly includes an upper sieve and a lower sieve.

13. The apparatus of claim 10 wherein grain separated by said shoe assembly falls under gravity toward the auger, and said cover is adapted and configured to allow substantially all of the falling grain to fall within the recess.

14. A method for separating grain, comprising:
providing a combine having a front and a rear and including a shoe assembly having at least one sieve and a pan under the sieve, an auger, and a fan for blowing air;
blowing air from the fan toward the shoe assembly;
permitting blown air to move over the auger, under the pan, and toward the rear; and
obstructing blown air from moving under the pan and toward the front.

15. The method of claim 14 wherein said combine includes an air valve under the pan, said air valve having a movable member which moves from a first position to a second position during said permitting.

16. The method of claim 14 wherein said combine includes an air valve under the pan, said air valve having a movable member which moves from a second position to a first position during said obstructing.

17. The method of claim 14 wherein said combine includes an air valve under the pan, said air valve having a movable member which is biased toward a closed position to encourage said obstructing.

18. The method of claim 17 wherein said biasing is by gravity.

19. The method of claim 17 wherein said biasing is by a spring.

20. The method of claim 14 wherein said combine includes an air valve under the pan, said air valve having a movable member which is biased toward an open position to encourage said permitting.

21. The method of claim 20 wherein said biasing is by gravity.

22. The method of claim 20 wherein said biasing is by a spring.
